(19) United States
(12) Patent Application Publication
(10) Pub. No.: US 2026/0083049 A1
(43) Pub. Date: Mar. 26, 2026

(54) ADJUSTABLE LIQUID FLOW SYSTEM FOR AGRICULTURAL IMPLEMENT

(71) Applicant: Kinze Manufacturing, Inc., Williamsburg, IA (US)

(72) Inventor: Matthew Wilhelmi, Williamsburg, IA (US)

(21) Appl. No.: 19/337,194

(22) Filed: Sep. 23, 2025

Related U.S. Application Data
(60) Provisional application No. 63/697,889, filed on Sep. 23, 2024.

(51) Int. Cl. A01C 23/00

(52) U.S. Cl. CPC A01C 23/007

(57) ABSTRACT

Flow through a manifold row flow assembly can be regulated by adjusting, either manually or automatically, an actuatable component of an adjustable flow insert placed adjacent a jet nozzle. The adjustable flow insert has a control surface designed to compress or expand the flow utilizing a geometry that pinches or diverts flow as it moves toward and away from the jet nozzle. This can increase the volume or velocity of flow through the manifold row flow assembly. Aspects of the flow near the jet nozzle is defined by a primary flow path through a central bore of the adjustable flow insert can remain open at all times, and an auxiliary flow path located radially outward from the first flow path. A cross-sectional area of the auxiliary flow path changes as the distance between the actuatable component of the adjustable flow insert and the adjacent jet nozzle changes.

### CROSS REFERENCE TO RELATED APPLICATIONS

This application claims priority under 35 U.S.C. § 119 (e) to provisional patent application Ser. No. 63/697,889, filed Sep. 23, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to an adjustable liquid flow system for an agricultural implement. More particularly, but not exclusively, the present disclosure relates to a insert for controlling flow in a liquid fertilizer system.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

In agricultural operations, herbicides, pesticides, fungicides, fertilizers, and the like are commonly sprayed in liquid form on fields or plants.

Previous liquid flow systems for agricultural implements have focused on more easily indicating fertilizer flow at all application rates using binary indication systems. The binary indication systems provided an indication of whether fertilizer is flowing, “yes or no”. While these simple systems are effective in providing fertilizer for agricultural operations, they do not provide the benefit of indicating flow rate ranges between a minimum expected flow rate and a maximum expected flow rate for said intended agricultural operations. As a result, there exists an ongoing need in the art to accurately measure rate(s) of liquid flow.

An example fertilizer flow meter assembly 90 is shown in FIG. 1. The fertilizer flow meter assembly 90 utilizes a paddle wheel 91, a nozzle orifice 92, a fertilizer shutoff 93, a fertilizer manifold cap 94, and a strainer nozzle 95 to control flow.

FIG. 2 shows the fertilizer flow meter assembly 90 in an assembled view. The fertilizer flow meter assembly 90 indicates either flow or no flow.

FIG. 3 shows the nozzle orifice 92 used downstream of the fertilizer flow meter assembly 90 in greater detail. The nozzle orifice 92 is intended to be used for all orifices small than 0.055 and not for 0.065 and larger.

FIG. 4 shows a paddle wheel 91 placed within the example fertilizer flow meter assembly 90.

FIG. 5 shows the nozzle orifice 92 once the paddle wheel 91 has been removed from the example fertilizer flow meter assembly 90.

FIG. 6 shows a table that allowed operators to find a beneficial strainer based on whether or not the jet orifice is being used and what size orifice is installed. These systems were thus able to utilize the standard OEM orifice downstream of the flow meter to control the flow rate. The single jet orifice upstream put product into the binary flow meter manifold and then out into a strainer which protects the OEM orifice downstream.

Initial attempts at determining and controlling the rates of liquid application are described in U.S. Pat. No. 9,310,233 to Schmidt and U.S. Pat. No. 8,191,795 Grimm et al.

U.S. Pat. No. 10,845,228 to Wilger et al. attempted to solve this problem by using multiple jet orifices within a single liquid flow system. Specifically, Wilger et al. developed a flow meter apparatus to measure a rate of liquid flow in a liquid conduit. The apparatus comprised a meter wheel housing adapted at an input port thereof for connection to an upstream end of the liquid conduit and adapted at an output port thereof for connection to a downstream end of the liquid conduit. When connected, liquid flowing in the liquid conduit flowed through the meter wheel housing from the input port to the output port. A meter wheel was rotatably mounted in the meter wheel housing about a wheel axis and configured such that liquid flowing from the input port to the output port caused the meter wheel to rotate, and a wheel sensor was operated to measure a rotational speed of the meter wheel. A first jet member defined a first orifice with a first cross-sectional area. The first jet member was configured to be moved into a jet operating position between the upstream end of the liquid conduit and the input port. This caused liquid to pass through the input port into the meter wheel housing only through the first orifice. A second jet member defined a second orifice with a second cross-sectional area. The second jet member was configured to be moved into the jet operating position. This caused liquid to pass through the input port into the meter wheel housing only through the second orifice. The second cross-sectional area was less than the first cross-sectional area.

Unfortunately, the utilization of multiple jet members complicates an otherwise simple device. While the flow meter apparatus of Wilger et al. is effective to measure a rate of liquid flow in a liquid conduit, the flow meter apparatus is costly and inefficient. While Wilger et al. also provides a method of measuring a rate of liquid flow through a liquid conduit, such a method still utilizes a plurality of jet members.

Thus, there exists a need in the art for an apparatus which utilizes a jet nozzle with only a single jet member while still allowing for the ability to provide and measure all nearly all rates of liquid flow

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to obtain the benefits of complex fluidic systems with smaller, simpler, and more reliable electromechanical components.

It is still yet a further object, feature, and/or advantage of the present disclosure to retrofit and install improvements such as the adjustable flow insert to existing fluidic systems commonly used in agricultural operations.

It is still yet a further object, feature, and/or advantage of the present disclosure to alleviate other known problems in liquid fertilizer systems with the adjustable flow insert. For example, the adjustable flow insert can be used in combination with the diaphragm pump to: (i) help the diaphragm pump prime; (ii) allow the diaphragm pump to reach the working pressure; (iii) mitigate the pressure gauge needle from fluctuating; (iv) deliver regular flow; (v) maintain a flow rate; (vi) mitigate noise from the pump; (vii) mitigate vibrations in the pump; (viii) prevent oil leaking from the seal; (ix) keep oil in the tank after oil has been topped off; and/or (x) prevent the oil in the tank from being a milky white color. In yet another example, the adjustable flow insert can be used in combination with the liquid fertilization system to: (i) better detect fertilizer flow; (ii) prevent unexpected fertilizer flow; (iii) lower fertilizer rail pressure when it is high; (iv) maintain fluid at the pump; (v) eliminate sensor errors; (vi) maintain an appropriate suction pressure; (vii) detect pump revolutions per minute; (viii) maintain hydraulic flow to the motor; (ix) prime the pump; (x) achieve an appropriate flow rate; (xi) read low flow rates; (xii) pull more fluid from an auxiliary tank; and (xiii) mitigate the analog pressure gauge needle from bouncing.

The adjustable flow insert disclosed herein can be used in a wide variety of applications. For example, the adjustable flow insert can be used to adjust flow of fluids other than liquid fertilizers and in macro-fluidic systems other than agricultural systems.

It is preferred that the adjustable flow insert be safe, cost effective, and durable. For example, it is desired to limit the effects of agricultural chemicals can cause death or serious injuries to persons, animals, and plants or seriously damage soil, equipment and property. Furthermore, tanks that store fertilizer can be designed to limit the risks of overfilling the tanks, thereby avoiding siphoning, tank collapse, personal injury, and damage to property and equipment. Sensors in the tank can help shutoff the tank prior to overfilling and/or can help the operator monitor the tanks while filling. Efficiencies can be gained where fertilizer system designs facilitate proper spacing between seeds and fertilizer such that the fertilizer is not placed too close to the seeds or in excessive amounts that can cause germination or seeding damage.

Methods can be practiced which facilitate use, manufacture, assembly, maintenance, and repair of an adjustable flow insert which accomplish some or all of the previously stated objectives.

The adjustable flow insert can be incorporated into systems or kits which accomplish some or all of the previously stated objectives.

According to some aspects of the present disclosure, an adjustable flow insert for a liquid flow system of an agricultural implement, the adjustable flow inset comprises an actuatable component having a control surface designed to compress or expand flow when moved in relation to an adjacent jet nozzle.

According to some additional aspects of the present disclosure, the adjustable flow insert is not capable of completely plugging the flow. The adjustable flow insert can have a bore through which flow is always permitted. The control surface can comprise an annular flange, a non-planar region, a tapered region, and/or an inflection point from which the surface switches from concave to convex.

According to some additional aspects of the present disclosure, the adjustable flow insert is constructed using additive manufacturing or formed from a mold.

According to some additional aspects of the present disclosure, the actuatable component actuates the control surface in a linear direction or actuates the adjacent jet nozzle so as to move toward and away from the control surface. The actuatable component can be electromagnetically actuated, such as with a solenoid.

According to some additional aspects of the present disclosure, the actuatable component comprises vents allowing some flow to always pass therethrough. The vents can be located toward a periphery of the annular flange. The adjustable flow insert preferably comprises radial symmetry.

According to some other aspects of the present disclosure, an adjustable liquid flow system comprises a fertilizer flow meter assembly; a jet nozzle; and an adjustable flow insert that is linearly actuatable with respect to the jet nozzle, said adjustable flow insert including a flow control surface that utilizes a geometry to control flow through the flow meter assembly.

According to some additional aspects of the present disclosure, the insert is located upstream of the jet nozzle.

According to some additional aspects of the present disclosure, the adjustable liquid flow system further comprises conduits carrying liquid fertilizer.

According to some additional aspects of the present disclosure, the fertilizer flow meter assembly is included as part of a manifold row flow assembly that also includes a fertilizer shutoff and a fertilizer manifold cap.

According to some additional aspects of the present disclosure, the adjustable liquid flow system further comprises the manifold row flow assembly further comprises a strainer nozzle and/or an orifice. An orifice in-line housing assembly can comprise the orifice, an orifice cushion adaptor, a connector, and a support tube.

According to some additional aspects of the present disclosure, the fertilizer flow meter assembly also includes a paddle wheel, a wire retention clip, a manifold fertilizer flow meter and a manifold flow meter cover. The manifold flow meter cover can comprise a dust cap assembly, a lower housing, a proximity sensor, a plastic shim, and/or a pair of O-rings.

According to some additional aspects of the present disclosure, the adjustable liquid flow system further comprises a positive displacement pump. The positive displacement pump can comprise a diaphragm pump.

According to some additional aspects of the present disclosure, the adjustable liquid flow system further comprises a fertilizer electric valve assembly, a pressure regulator, a fertilizer electric valve assembly, a notched single disc fertilizer opener, plumbing from a bulk hopper, and/or plumbing to a rear hitch.

According to other additional aspects of the present disclosure, a method of regulating flow through a manifold row flow assembly, the method comprises adjusting an actuatable component of an adjustable flow insert having a control surface designed to compress or expand flow when moved in relation to an adjacent jet nozzle.

According to some additional aspects of the present disclosure, the method further comprises increasing the flow through the manifold row flow assembly.

According to some additional aspects of the present disclosure, the method further comprises increasing the flow through the manifold row flow assembly.

According to some additional aspects of the present disclosure, the method further comprises allowing a first flow path through the actuatable component to remain open.

According to some additional aspects of the present disclosure, the method further comprises allowing a second flow path, located radially outward from the first flow path, to move from open to completely closed depending on a distance between the actuatable component of the adjustable flow insert and the adjacent jet nozzle.

According to some additional aspects of the present disclosure, the method further comprises electromagnetically actuating the actuatable component to move the actuatable component in a linear direction.

According to some additional aspects of the present disclosure, the method further comprises venting some flow at a periphery of the adjustable flow insert.

According to some additional aspects of the present disclosure, the method further comprises mounting a row unit and the manifold row flow assembly to a toolbar of an implement with an extended mount, a flat mount, or a right-angle mount.

According to some additional aspects of the present disclosure, the control surface comprises an annular flange, a non-planar region, and/or a tapered region.

According to some additional aspects of the present disclosure, the row unit comprises a notched single disc fertilizer opener.

According to some additional aspects of the present disclosure, the auxiliary flow path grows in cross-sectional size as the adjustable flow insert moves away from the jet nozzle.

According to some additional aspects of the present disclosure, an inner central flow through the insert includes a higher flow rate than an outer peripheral flow when the adjustable flow insert is closer to the jet nozzle.

According to some additional aspects of the present disclosure, the method further comprises reducing flow rate with an anti-slip surface of the adjustable flow insert. The anti-slip surface forms part of the control surface.

According to some additional aspects of the present disclosure, the method further comprises forming a uniform flow near an inlet of the jet nozzle.

According to some additional aspects of the present disclosure, the method further comprises forming a non-uniform flow near the actuatable component of the adjustable flow insert. The adjustable flow insert is permanently sealed within the manifold row flow assembly and cannot be replaced.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows an exploded view of an example fertilizer flow meter assembly that is known in the art.

FIG. 2 shows a perspective view of the fertilizer flow meter assembly of FIG. 1 in assembled form.

FIG. 3 shows a detailed view of the nozzle orifice of the fertilizer flow meter assembly of FIG. 1.

FIG. 4 shows a partially hidden view revealing the position of a paddle wheel placed within the fertilizer flow meter assembly of FIG. 1.

FIG. 5 shows a partially hidden view revealing the position of the nozzle orifice within the fertilizer flow meter assembly of FIG. 1.

FIG. 6 shows a table that allowed operators to find a beneficial strainer based on whether or not the jet orifice is being used and what size orifice is installed.

FIG. 7 shows an exploded view of an improved manifold row flow assembly that includes an adjustable insert for controlling flow within a liquid flow system for an agricultural implement, according to some aspects of the present disclosure.

FIG. 8A shows a detailed view of the adjustable insert with the improved manifold row assembly of FIG. 7 in a first position, according to some aspects of the present disclosure.

FIG. 8B shows a detailed view of the adjustable insert with the improved manifold row assembly of FIG. 7 in a second position, according to some aspects of the present disclosure.

FIG. 8C shows a detailed view of the adjustable insert with the improved manifold row assembly of FIG. 7 in a third position, according to some aspects of the present disclosure.

FIG. 9 emphasizes insertion of a jet orifice into a center hole on the row shut valves, the rib of which is aligned with a groove in the housing, according to some aspects of the present disclosure.

FIG. 10 emphasizes proper installation of a filtering device in the improved manifold row assembly of FIG. 7, according to some aspects of the present disclosure.

FIG. 11 emphasizes proper installation of a gasket assembly of the improved manifold row assembly of FIG. 7, according to some aspects of the present disclosure.

FIG. 12 shows an exploded view of a fertilizer flow meter assembly, according to some aspects of the present disclosure.

FIG. 13 emphasizes a u-bolt for the fertilizer flow meter assembly of FIG. 12, according to some aspects of the present disclosure.

FIG. 14 shows an exploded view of a manifold flow meter cover for the fertilizer flow meter assembly of FIG. 12, according to some aspects of the present disclosure.

FIG. 15 shows an exploded view of the orifice in-line housing assembly of the fertilizer flow meter assembly of FIG. 12, according to some aspects of the present disclosure.

FIG. 16 shows a digital view of a user interface for controlling aspects, such as tank leveling, of an adjustable liquid flow system, according to some aspects of the present disclosure.

FIG. 17 shows a schematic drawing of the liquid fertilizer application system, according to some aspects of the present disclosure.

FIG. 18 shows a schematic drawing of the liquid fertilizer application system for a rear trailer or hitch auxiliary tank, according to some aspects of the present disclosure.

FIG. 19 shows a perspective view of an example liquid fertilizer system, according to some aspects of the present disclosure.

FIG. 20 shows the example liquid fertilizer system of FIG. 19 at the wing of an agricultural implement, according to some aspects of the present disclosure.

FIG. 21 shows hose routing, with auxiliary, for the example liquid fertilizer system of FIG. 19, according to some aspects of the present disclosure.

FIG. 22 shows hose routing, without auxiliary, for the example liquid fertilizer system of FIG. 19, according to some aspects of the present disclosure.

FIG. 23 shows a detailed view of the example liquid fertilizer system of FIG. 19 within detail bubble 23, according to some aspects of the present disclosure.

FIG. 24 shows a detailed view of the example liquid fertilizer system of FIG. 19 within detail bubble 24, according to some aspects of the present disclosure.

FIG. 25 shows a detailed view of the example liquid fertilizer system of FIG. 20 within detail bubble 25, according to some aspects of the present disclosure.

FIG. 26 shows a detailed view of the example liquid fertilizer system of FIG. 20 within detail bubble 26, according to some aspects of the present disclosure.

FIG. 27 shows a detailed view of the example liquid fertilizer system of FIG. 19 within detail bubble 27, according to some aspects of the present disclosure.

FIG. 28 shows a detailed view of the example liquid fertilizer system of FIG. 19 within detail bubble 28, according to some aspects of the present disclosure.

FIG. 29 shows a detailed view of the example liquid fertilizer system of FIG. 19 within detail bubble 29, according to some aspects of the present disclosure.

FIG. 30 shows a first perspective view of a fertilizer manifold, according to some aspects of the present disclosure.

FIG. 31 shows a second perspective view of a fertilizer manifold, according to some aspects of the present disclosure.

FIG. 32 shows component views of a fertilizer manifold, according to some aspects of the present disclosure.

FIG. 33 shows a perspective view of fertilizer tank system, according to some aspects of the present disclosure.

FIG. 34 shows a detailed view of the fertilizer tank system of FIG. 33 within detail bubble 34, according to some aspects of the present disclosure.

FIG. 35 shows a detailed view of the fertilizer tank system of FIG. 33 within detail bubble 35, according to some aspects of the present disclosure.

FIG. 36 shows a detailed view of the fertilizer tank system of FIG. 33 within detail bubble 36, according to some aspects of the present disclosure.

FIG. 37 shows a detailed view of the fertilizer tank system of FIG. 33 within detail bubble 37, according to some aspects of the present disclosure.

FIG. 38 shows a detailed view of the fertilizer tank system of FIG. 33 within detail bubble 38, according to some aspects of the present disclosure.

FIG. 39 shows a detailed view of the fertilizer tank system of FIG. 33 within detail bubble 39, according to some aspects of the present disclosure.

FIG. 40 shows a detailed view of the fertilizer tank system of FIG. 33 within detail bubble 40, according to some aspects of the present disclosure.

FIG. 41 shows a detailed view of the fertilizer tank system of FIG. 33 within detail bubble 41, according to some aspects of the present disclosure.

FIG. 42 shows a detailed view of the fertilizer tank system of a rear trailer hitch option, according to some aspects of the present disclosure.

FIG. 43 shows an exploded view of a fertilizer electric valve assembly, according to some aspects of the present disclosure.

FIG. 44 shows a perspective view of a flow meter assembly, according to some aspects of the present disclosure.

FIG. 45 shows a perspective view of a planter, according to some aspects of the present disclosure.

FIG. 46 shows a perspective view of a diaphragm pump, according to some aspects of the present disclosure.

FIG. 47 shows a perspective view of a diaphragm pump assembly, according to some aspects of the present disclosure.

FIG. 48 shows a perspective view of a fertilizer junction assembly, according to some aspects of the present disclosure.

FIG. 49 shows a perspective view of tank port assemblies, according to some aspects of the present disclosure.

FIG. 50 shows a perspective view of a fertilizer level sight assembly, according to some aspects of the present disclosure.

FIG. 51 shows an exploded view manifold y strainer assemblies, according to some aspects of the present disclosure.

FIG. 52 shows an exploded view of a pressure regulator, according to some aspects of the present disclosure.

FIG. 53 shows front hitch plumbing, according to some aspects of the present disclosure.

FIG. 54 shows a detailed view of the front hitch plumbing of FIG. 53 within detail bubble 54, according to some aspects of the present disclosure.

FIG. 55 shows a detailed view of the front hitch plumbing of FIG. 53 within detail bubble 55, according to some aspects of the present disclosure.

FIG. 56 shows a detailed view of the front hitch plumbing of FIG. 53 within detail bubble 56, according to some aspects of the present disclosure.

FIG. 57 shows a detailed view of a rear trailer hitch, according to some aspects of the present disclosure.

FIG. 58 shows a detailed view of the rear hitch trailer of FIG. 57 within detail bubble 58, according to some aspects of the present disclosure.

FIG. 59 shows a detailed view of the rear hitch trailer of FIG. 57 within detail bubble 59, according to some aspects of the present disclosure.

FIG. 60 shows a detailed view of the rear hitch trailer of FIG. 57 within detail bubble 60, according to some aspects of the present disclosure.

FIG. 61 shows a detailed view of a notched single disc fertilizer opener, according to some aspects of the present disclosure.

FIG. 62 shows additional aspects of the notched single disc fertilizer opener of FIG. 61 within detail bubble 62, according to some aspects of the present disclosure.

FIG. 63 shows additional aspects of the notched single disc fertilizer opener of FIG. 61 within detail bubble 63, according to some aspects of the present disclosure.

FIG. 64 shows example mounting hardware, in this instance an extended mount, for the notched single disc fertilizer opener of FIG. 61, according to some aspects of the present disclosure.

FIG. 65 shows example mounting hardware, in this instance a right angle mount, for the notched single disc fertilizer opener of FIG. 61, according to some aspects of the present disclosure.

FIG. 66 shows example mounting hardware, in this instance an extended mount, for the notched single disc fertilizer opener of FIG. 61, according to some aspects of the present disclosure.

FIG. 67 shows example mounting hardware, in this instance a flat mount, for the notched single disc fertilizer opener of FIG. 61, according to some aspects of the present disclosure.

FIG. 68 shows a detailed view of a liquid fertilizer tube in furrow, according to some aspects of the present disclosure.

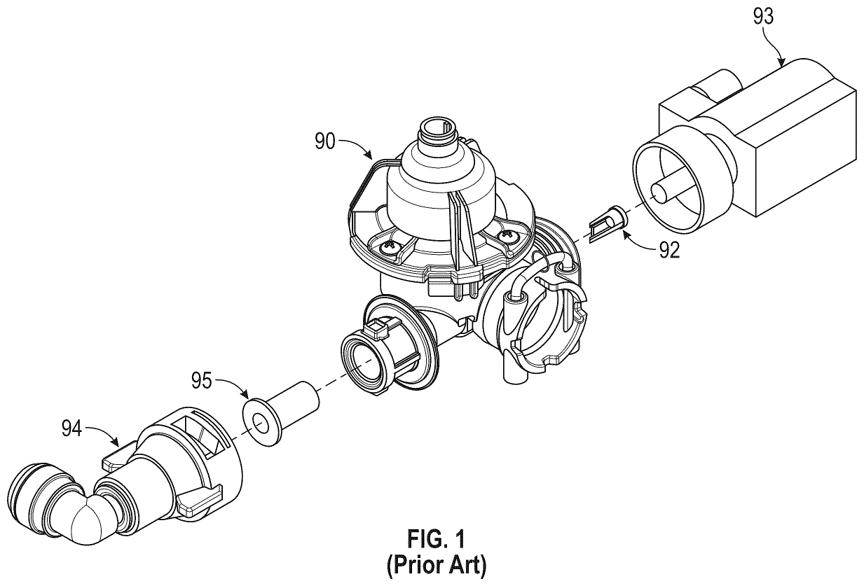

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

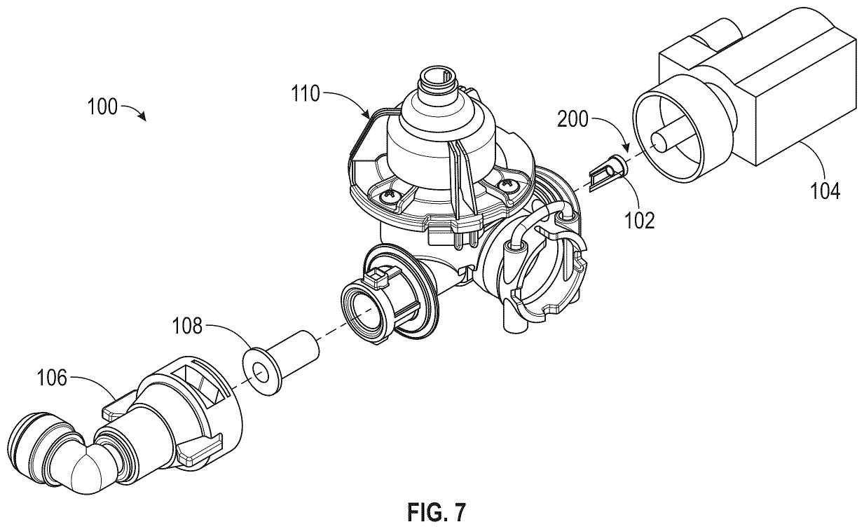

FIGS. 7-15 shows an exploded view of an improved manifold row flow assembly 100 that includes an adjustable insert 200 for controlling flow 300 within a liquid flow system for an agricultural implement.

As shown in FIG. 7, the fertilizer flow meter assembly 110 is included as part of the manifold row flow assembly 100 that also includes a fertilizer shutoff 104, a fertilizer manifold cap 106, and a strainer nozzle 108.

Pressure to the liquid fertilizer supply to the improved manifold row flow assembly 100 is somewhat constant. It can vary some, but nothing significant. The pressure difference between the liquid fertilizer supply and the environment is substantially constant.

The volumetric flow rate through the fertilizer flow meter assembly 110 depends on the difference in pressure and size of the jet orifice 102. Orifice properties, including the geometry of the jet orifice 102, edge shape, and fluidic properties each play a role in volumetric flow rate. The faster the volumetric flow rate through the jet orifice 102, the higher the pressure loss that occurs. For a fixed orifice, increases in pressure must result in a corresponding decrease in velocity according to Bernoulli's principle, which assumes frictionless flow:

$$P + \frac{1}{2} ρ {v}^{2} + ρ gh = constant$$

wherein P represent the pressure of the fluid, ρ represents the density of the fluid, v represent the velocity of the fluid, g represents acceleration due to gravity, and h represents the height of the fluid relative to a reference height within the pipe. This means that, when considering two different points for the flow 300, this equation can be rewritten as:

$${P}_{1} + \frac{1}{2} {ρ}_{1} {v}_{1}^{2} + {ρ}_{1} {gh}_{1} = {P}_{2} + \frac{1}{2} {ρ}_{2} {v}_{2}^{2} + {ρ}_{2} {gh}_{2}$$

So, for a fixed jet orifice 102, doubling volumetric flow at one location requires the pressure difference to be four times as high.

Recognizing that there is friction in real flows (e.g., the flow 300), energy is lost when the fluid is forced to change how it flows. This can be frictional losses from the pipe walls, turbulent mixing from changing pipe diameter or pipe bends. All of these losses affect how the piping system behaves as a whole. A lot of pressure losses because of valves, bends, junctions, etc. require more pressure (energy) to achieve the same flowrate.

As such, using a minimalist approach to including components that can affect aspects of the flow 300 is therefore very attractive, and the ability to adjust aspects of the flow 300 based on reducing effects of friction or losses that occur due to drastic changes in geometry or even the use of pipe sections and nozzles with different functional configurations because of their distinct geometries can be very beneficial in existing liquid fertilizer systems 400, 500 on agricultural implement(s) 1000.

The volumetric flow is proportional to the cross-sectional area of the jet orifice, as shown below:

$$Q = vA$$

wherein Q represents volumetric flow rate, v represents flow velocity, and A represents the cross-sectional vector area. Because the liquid fertilizer pressure at the source is constant, flow rate drops as the orifice gets smaller. An increase in the fertilizer pressure at the source as the orifice gets smaller keeps the flow rate constant. All restrictions in the liquid fertilizer system play a role with this, not just the final valve or orifice size. Every bend, straight, tee, etc. will impact the flow, many of which are affected by the difference in height of the bends, straights, tees, with respect to the reference height. The impact of these components can play a key role in the flow even if the difference cannot be seen.

Additionally, it should be recognized that in existing fluidic fertilization systems, the entrance length and exit lengths, which relate to the distances the flows must travels after entering or exiting a pipe before the flow becomes fully developed, can also affect the efficiency of the fertilization systems. Entrance length refers to the length of the entry region, the area following the pipe entrance where effects originating from the interior wall of the pipe propagate into the flow as an expanding boundary layer. Exit length, similar to the development of flow at the entrance of the pipe, changes the flow velocity profile before the exit of a pipe; the exit length is much shorter than the entrance length, and is negligible at moderate to high Reynolds numbers.

When the boundary layer expands to fill the entire pipe, the developing flow 300 becomes a fully developed flow, where flow characteristics no longer change with increased distance along the pipe. Many different entrance and exit lengths exist to describe a variety of flow conditions. Hydrodynamic entrance and exit lengths describe the formation of a velocity profile caused by viscous forces propagating from the pipe wall. Thermal entrance length describes the formation of a temperature profile. Awareness of entrance length may be necessary for the effective placement of instrumentation, such as fluid flow meters.

Many types of flow instrumentation, such as flow meter assemblies 110, can require a fully developed flow to function properly. Common flow meters, including vortex flow meters and differential-pressure flow meters, require hydrodynamically fully developed flow. Hydraulically fully developed flow is commonly achieved by having long, straight sections of pipe before the flow meter 110.

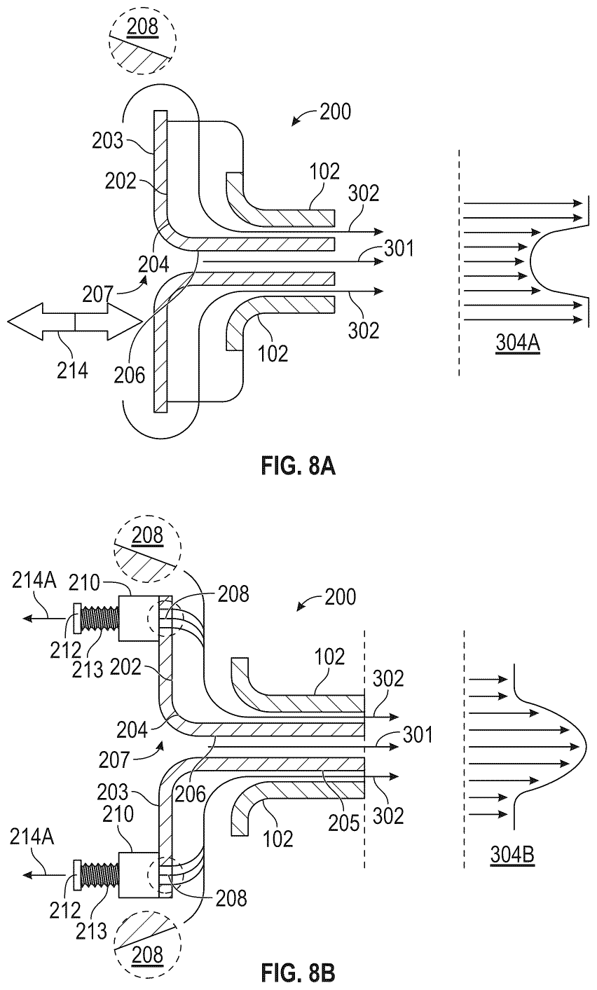

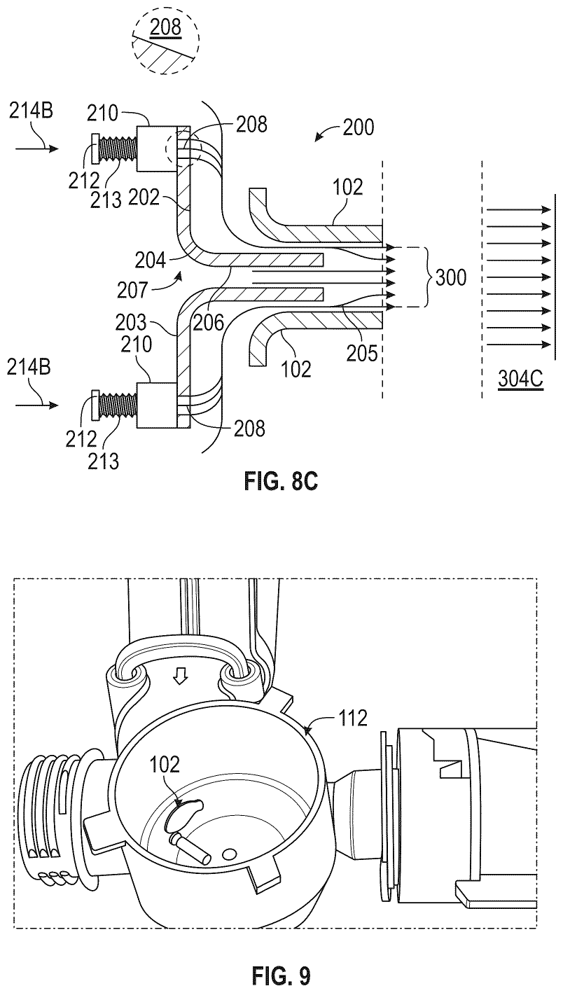

FIGS. 8A-8C in particular show an adjustable insert 200 in various positions. Each position utilizes the adjustable inserts 200 unique geometries can adjust aspects of the flow, including entry and exit lengths, to improve function of the flow meter assembly 110. The adjustable flow insert 200 can therefore not only function similarly to a valve, but also as a flow conditioner or straightening device to produce the desired flow 300 to enter (or exit) the jet nozzle 102.

The adjustable flow insert 200 includes a control surface 202-206 designed to compress or expand the flow 300 when moved in relation to the adjacent jet nozzle 102. As shown, the control surface(s) 202-206 comprises a planar region 202, an annular flange 203, a non-planar region 204, an inflection point 205, and a tapered region 206. The unique geometry of the adjustable flow insert 200 controls a velocity or a volume of the flow 300 to adjust flow rate of a fluid through the flow meter assembly 110. For example, the cross-sectional area of the auxiliary flow path 302 near the adjacent jet nozzle 102 decreases from a maximum area at a first, open position to zero area at a second, completely closed position, and further wherein the cross-sectional area depends on a distance between the actuatable component 210 of the adjustable flow insert 200 and the adjacent jet nozzle 102. The cross-section area of the primary flow path 301 remains constant.

The adjustable flow insert 200 can be constructed using additive manufacturing or the formed from a mold. The adjustable flow insert 200 can be constructed so as to include an anti-slip surface that can reduce velocity of the flow 300 near the surface. The anti-slip surface forms part of the control surface 202-206.

Vents 208 located toward a periphery of the annular flange 203 can be included to allow some of the flow 300 to pass therethrough. The vents 208 can have an always open configuration, for simplicity of parts used in the adjustable insert 200. In still other embodiments, the vents 208 can be configured such that they can be opened and closed.

The vents 208 can allow the adjustable insert 200 to further behave as a flow conditioner, that is: use of the adjustable insert 200 to ensure that the real-world flow 300 more closely resembles a frictionless flow for proper performance of the flow meter assembly 110. The vents 208 can help eliminate swirls at the pipe's boundary, asymmetries at pipe boundaries, or to fully develop the flow 300 near the jet nozzle 102. The vents 208 of the adjustable flow insert 200 can thus function similarly to honeycombs, and the number of vents 208 can be increased if the diameter of the vents 208 is decreased or the space between said vents 208 is decreased.

The present disclosure does not limit in any way the number of vents 208 that can be utilized, or the configuration/orientation that they utilize. The vents 208 can formed from openings with walls perpendicular to the pipe's boundaries, or from walls that angle the flow 300 toward the jet orifice 102. The vents 208 can be radially positioned within said annular flange 203.

The overall shape of the adjustable insert 200 can comprise radial symmetry or radial asymmetry. Radial symmetry is particularly effective in controlling a more uniform flow 300, while radial asymmetry allows for the adjustable insert 200 to include grooves or protrusions that can help lock the adjustable insert 200 into an operable position. The inclusion of radially symmetric vents 208 that can be selectively opened and closed could allow a radially symmetric adjustable flow insert 200 to achieve asymmetric flows if only some of the ports are closed.

In some embodiments, the adjustable flow insert 200 includes aspects that are common to a sleeve valve. The adjustable flow insert 200 can open and close primary or secondary flow paths based on ports located in the sleeve which is placed within the jet nozzle 102. As the sleeves moves, the ports in the periphery of the sleeves come into alignment with the cylinder's inlet and exhaust ports. The ports can be included in addition to vents 208 or in lieu thereof.

An actuatable component 210 actuates the control surface 202-206 in a linear direction 214. In a first example, the actuatable component 210 actuates the adjacent jet nozzle 102 so as to move toward and away from the control surface 202-206, while the jet insert remains static. In a second example, the actuatable component 210 directly actuates the adjacent jet nozzle 102 so as to move toward and away from the control surface 202-206, while the control surface 202-206 remains static. In a third example, the actuatable component 210 directly actuates both the adjacent jet nozzle 102 and the control surface 202-206 to move toward and away from one another. The first example is preferable in embodiments where the adjustable flow insert 200 can be retrofit to existing row flow manifold assemblies 100. The second and third examples are preferable where the adjustable flow insert 200 is permanently sealed within the manifold row flow assembly 100 and cannot be replaced.

For example, the actuatable component 210 can be electromagnetically actuated and controlled with an automatic switch and/or a switch in the cab of the agricultural implement. Such electromagnetic actuation can be accomplished with the magnetic actuator shown in FIGS. 8B-8C. The actuatable component 210 includes a first magnetic component. A second magnetic component 212 that attracts or repels the first magnetic component 210 is placed between an actuator that includes a biasing mechanism, such as the spring 213. The biasing mechanism can be biased to keep the actuator in a retracted, extended, or neutral position, and the types of magnets used should be able to provide force in an opposite direction 214A to the direction 214B of the force provided by the spring 213.

In some embodiments, the adjustable flow insert 200 is not capable of completely plugging the flow. For example, the adjustable flow insert 200 has a central bore 207 through which a first flow 301 is always permitted.

In one embodiment, the auxiliary flow path 302 increases in cross-sectional size as the adjustable flow insert 200 moves away from the jet nozzle 102. The inner central flow 301 through the insert includes a higher flow rate than an outer peripheral flow 302 when the adjustable flow insert 200 is closer to the jet nozzle 102.

In the embodiment shown in FIG. 8A, the resultant combination flow 300 near the jet nozzle 102 is a divested flow profile 304A wherein the peripheral flow 302 in the cross-section includes greater pressure and forces the flow toward the center of the jet nozzle 102 which includes a lower pressure from the inner flow 301. In the embodiment shown in FIG. 8B, the resultant combination flow 300 near the jet nozzle 102 is a focused flow profile 304B wherein the inner flow 301 in the cross-section includes more pressure and forces the outwardly toward the periphery of the nozzle which includes a lower pressure from the outer flow 302. In the embodiment shown in FIG. 8C, the resultant combination flow 300 near the jet nozzle 102 is a uniform flow profile 304C wherein the peripheral flow 302 in the cross-section includes an equal pressure and the flow proceeds as usual toward the jet nozzle 102. In some embodiments, the adjustable flow insert 200 can achieve all three positions and allow for all three potential resultant flows 300 with flow profiles 304A-304C near the adjacent jet nozzle 102. In other embodiments, the adjustable flow insert 200 can achieve a combination of two of the three positions and allow for any two of the three potential resultant flows 300 with flow profiles 304A-304C near the adjacent jet nozzle 102.

All restrictions in the system play a role with this, not just the final valve. Every bend, straight, tec, or the like, will impact the flow 300. The impact of these components play a role in the flow even if you can't see if the difference.

As shown in FIGS. 9-11, the row flow meter jet nozzle can be removed by turning manifold flow meter cover 128 counterclockwise and unlocked and the manifold flow meter cover 128 removed from the manifold row flow assembly 100. The paddle wheel 130 can be removed from the paddle wheel cavity 112. The jet nozzle assembly 116 can be removed by turning the nozzle assembly counterclockwise ninety degrees and pulling same off. The strainer 108 can then be pulled out of the manifold row flow assembly 100. Thereafter, the row shutoff valve 104 can be removed by spinning the nut 118 counterclockwise and pulling the valve out. The initial position of the jet nozzle 102 within the paddle wheel cavity 112 is best seen in FIG. 9. The jet nozzle 102 (also referred to as a jet orifice) can be removed by pushing the jet nozzle 102 out of the paddle wheel cavity 112 by pushing from within the jet nozzle 102 (such as with a screwdriver).

In embodiments wherein the adjustable insert 200 is retrofit to existing systems, the adjustable insert 200 can then be placed behind (upstream) where the jet nozzle 102 sat within the paddle wheel cavity 112, before the jet nozzle 102 is reinstalled. Alternatively, the adjustable insert 200 can be placed attached to the jet nozzle 102 such that they can be reinstalled as a single unit.

To reinstall the row flow meter jet orifice 102, the jet orifice can be placed at the tip of a blunt object (such as a screwdriver), with the long tip closest to the rail and pointing toward the paddlewheel cavity 112. The jet orifice 102 is then inserted into a center hole on the row shut off valves 104, and the jet orifice 102 is gently twisted back and forth to help align the rib on the orifice and the groove in the housing. The jet nozzle 102 should be flush with a wall of the paddle wheel cavity 112 when installed completely.

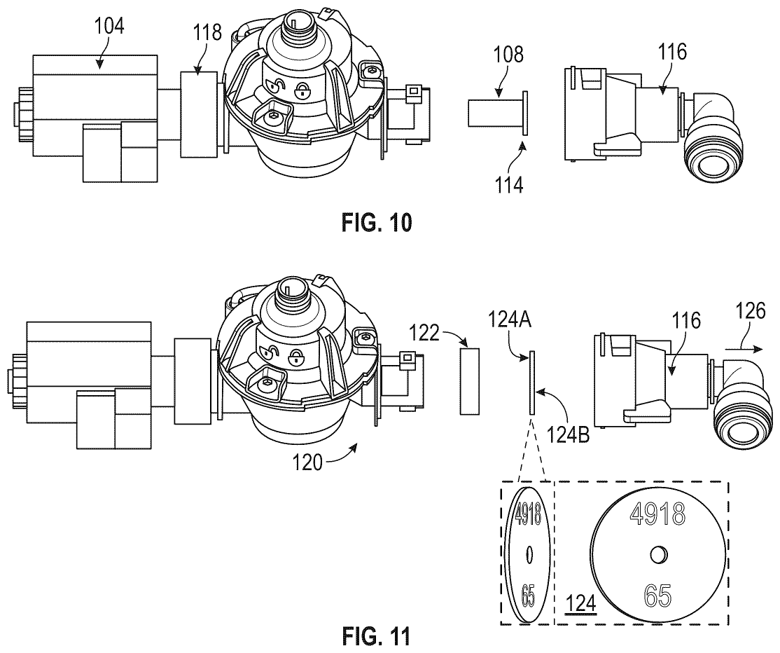

As shown in FIG. 10, the row shutoff valve 104 is then reinstalled and the nut 108 tightened clockwise. The paddle wheel 130 can be placed back onto a pin inside the paddle wheel cavity 112. The paddle wheel 130 can then be spun to ensure it is seated correctly within the paddle wheel cavity 112. The manifold flow meter cover 128 is then reinstalled by turning it clockwise until the lock symbol shows the manifold flow meter cover 128 is secured in place (e.g. a while line directly aligned with said lock symbol). The strainer 108, gasket 122, orifice 124, and nozzle assembly 116 can then be reinstalled in such order, as shown in FIG. 11. The orifice 124 should be installed with the blank side 124A facing the gasket 122 and the stamped side 124B facing the nozzle assembly 116.

Fertilizer can salt out when certain conditions of time and temperature are met. This can cause buildup of fertilizer granules in and around areas of low flow. This will cause errors in the performance of the fertilizer flow manifold. To properly clean, the entire assembly is disassembled. All parts are cleaned thoroughly with clean water at the end of planting season or prior to an extended period of non-use. The fertilizer should not be allowed to be crystallize from cold temperatures or evaporation.

To open the manifold row flow assembly 100, the manifold flow meter cover 128 is rotated counterclockwise and unlocked. The manifold flow meter cover 128 is then removed form the manifold row flow assembly 100. The paddle wheel 130 can be removed from the paddle wheel cavity 112. All parts an be cleaned thoroughly with clean water. Debris inside the paddle wheel cavity 112 can then be removed. Once clean, the paddle wheel 130 can be placed back onto a pin inside the paddle wheel cavity 112. The paddle wheel 130 can then be spun to ensure it is seated correctly within the paddle wheel cavity 112. The manifold flow meter cover 128 is then reinstalled by turning it clockwise until the lock symbol shows the manifold flow meter cover 128 is secured in place (e.g. a while line directly aligned with said lock symbol).

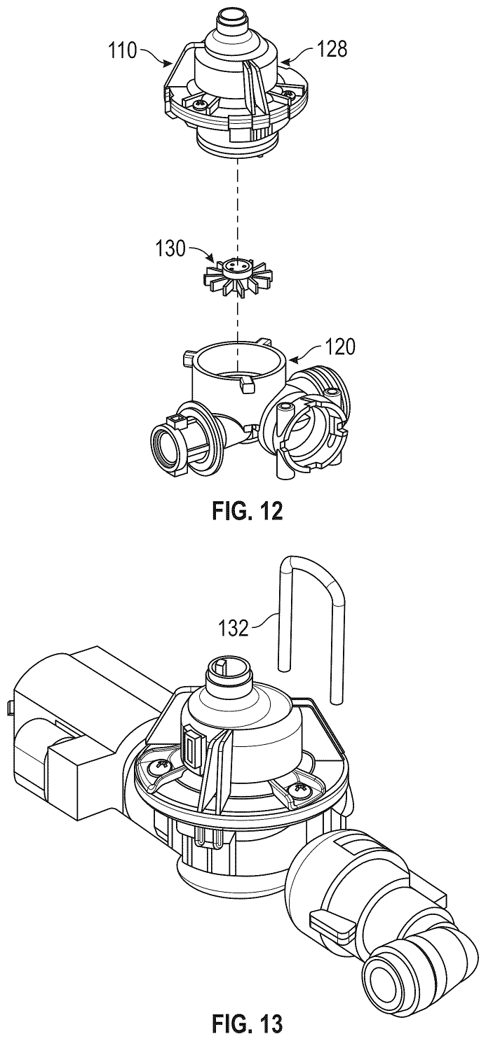

The fertilizer flow meter assembly 110 further comprises a paddle wheel 130, a flow meter manifold 120, and a manifold flow meter cover 128, as shown in FIG. 12. The paddle wheel 130 acts as a form of waterwheel or impeller in which a number of paddles are set around the periphery of the paddle wheel 130. Flow meters assembled into a manifold valve block 120 allow the user to see, measure, and control the rate of flow in different lines. The manifold flow meter cover 128 protects the internal components of the flow meter manifold 120.

The wire retention clip 132 secures the manifold flow meter cover 128 to the flow meter manifold 120, as shown in FIG. 13.

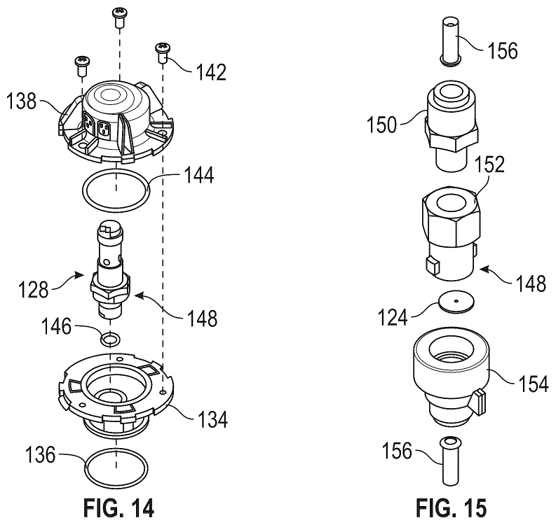

The manifold flow meter cover 128 comprises a dust cap assembly 138 and a lower housing 134, as shown in FIG. 14. The manifold flow meter cover 128 comprises a proximity sensor 140, which is a non-contact sensor that detects the presence of flow and other objects. The plastic shim 146 holds heavy objects in place until they are permanently attached with the pan head tapping screws 142. A pair of O-rings 144 seal gaps between the dust cap assembly 138 and the lower housing 134, and the lower housing 134 (which is open at the bottom) and the flow meter manifold 120.

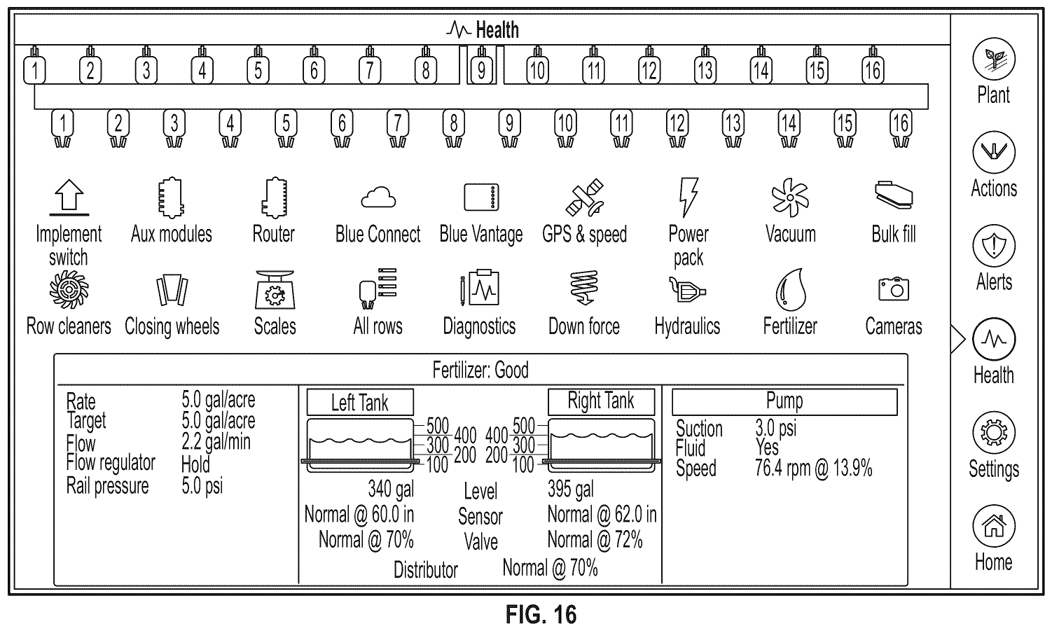

The manifold row flow assembly 100 further includes an orifice 124. The orifice is included in an orifice in-line housing assembly 148, as shown in FIG. 15. The orifice in-line housing assembly 148 also includes a first support tube 156, a connector 150, an orifice cushion adaptor 152, the orifice 124, a cap 154, and a second support tube 156, which are concentrically oriented with respect to one another in such order (top to bottom). FIG. 16 shows a digital view of a user interface for controlling aspects, such as tank leveling, of an adjustable liquid flow system. Some additional, controllable aspects of the agricultural implement (planter) and row units of the user interface with respect to the planter are shown and described in co-owned U.S. Pre-grant Pub. Nos., 2021/0315151, 2021/0337717, 2021/0337718, 2021/0341944, and 2021/0337723, each of which is hereby incorporated by reference herein.

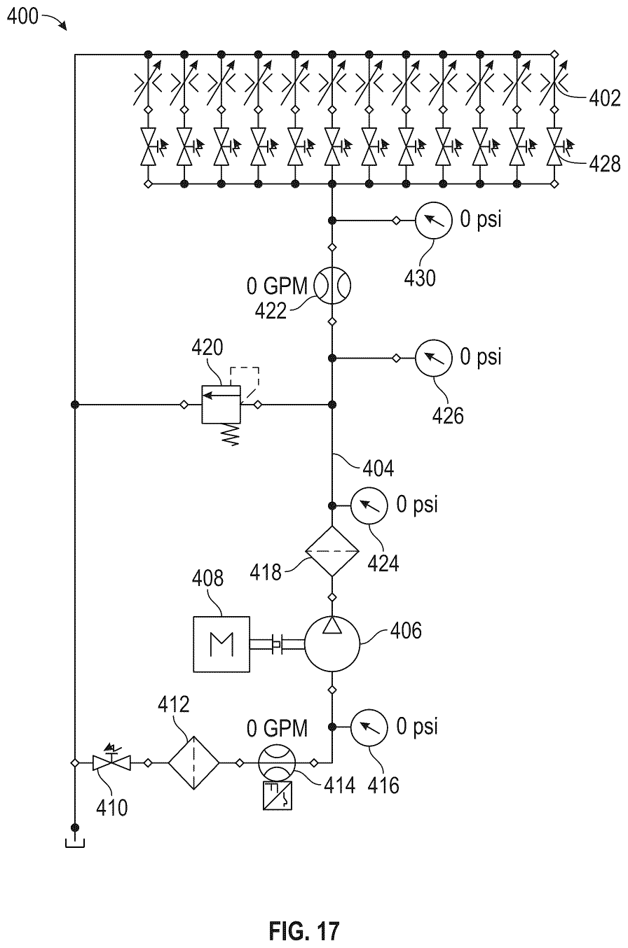

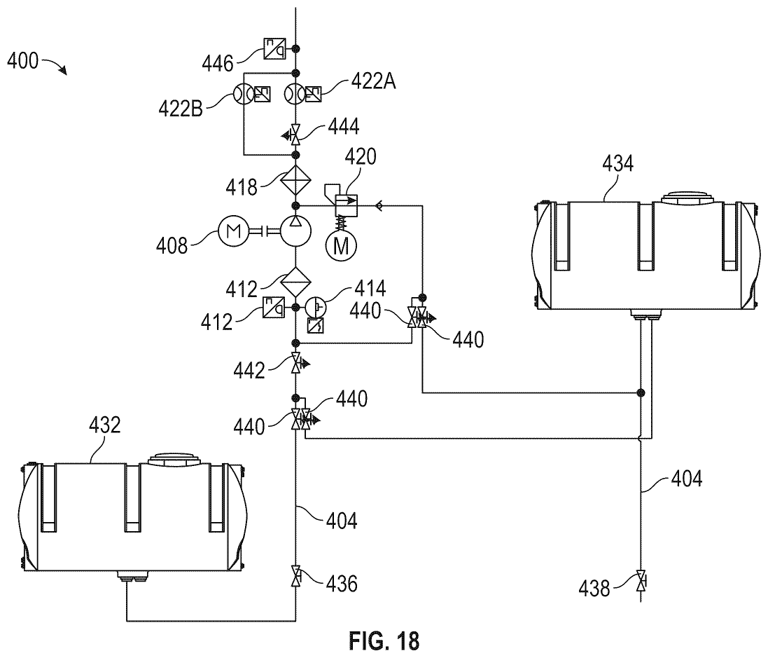

FIGS. 17-18 depict an example of a liquid fertilizer application system 400. The improved adjustable liquid flow system 100 places an actuatable component 210 that allows for flow to be adjusted at each fertilizer flow meter assembly 110 for each row unit 402 of an agricultural planter.

A supply, such as in the form of one or more hoppers, is provided. The supply can be in the form of bulk hoppers for all row units 402, hoppers for a collection or region of units, or could be provided on-row for each of the row units 402. In the embodiments shown, the supply is considered to be of the bulk hopper type. The liquid fertilizer reaches each of the row units from the supply via one or more conduits 404 and a positive displacement pump 406. Positive displacement pumps 406 can include, but are not limited to, diaphragm pumps, helical rotors (progressive cavity pumps), peristaltic hose pumps, piston pumps, and rotary lobes (gear pumps). The embodiment shown in FIG. 17 includes a diaphragm pump. The diaphragm pump shown in FIG. 17 operates by way of a drive source 408, which is shown to be a hydraulic motor. However, it should also be appreciated that other types of pumps, including the diaphragm pump, could be driven with an electric motor.

Still further, the supply or source for the liquid fertilizer could take many forms, including, but not limited to, a hopper or hoppers, a towed trailer tank or tanks, planter mounted tank or tanks, and/or tractor mounted tank or tanks.

Once the liquid fertilizer is pulled from the supply, the liquid fertilizer passes through an electric ball valve 410. This electric ball valve 410 is in place for either the immediate shutoff or operation of the system.

After the liquid fertilizer passes through the electric ball valve 410, the liquid then goes through a filtering device 412, which is shown to be a suction strainer, to mitigate particulate matter from entering and damaging the positive displacement pump 406. Particularly, a suction strainer that has an integrated foot valve prevents the suction line from running empty after the pumping operation has been completed. After the liquid travels through the filtering device 412, the liquid then flows through a flow switch 414 to confirm the presence of the fluid coming into and through the system. This will aid in mitigating and/or avoiding extended time of positive displacement pump cavitation. Placing the flow switch 414, rather than a flow meter, before the positive displacement pump 406 also offers versatility, lowers cost, and improves the overall accuracy of the liquid fertilizer application system 400. The flow switch 414 can function by sending trip signals to the positive displacement pump 406, which can further communicate to the positive displacement pump 406 to shut off or to turn on. Thus, the flow switch 414 can protect the positive displacement pump 406 from damage and provides the benefit of cooling circuit protection.

Following the flow switch 414 is a pressure gauge 416, which is used to check the pressure of the line prior to the liquid passing through the positive displacement pump 406. As noted, the system as shown includes a diaphragm pump and hydraulic motor for operating the pump. Diaphragm pumps provide numerous advantages, including, but not limited to, the ability to handle a wide variety of fluids with high solids content, being self-priming, the ability to run dry, being generally explosion proof, having generally constant pumping efficiency, providing variable flow rate and discharge pressure, not overheating, not requiring mechanical seals, couplings, or motors, being submersible, being portable, being dead head, requiring simple installation, having high pressure capabilities, not requiring pressure relief or bypass, having shear sensitivity, and being easily maintained and also relatively inexpensive.

Another filtering device 418, in the form of a pressure strainer, follows the positive displacement pump 406, and is designed to protect the hydraulic lines, pressure regulator 420, and flowmeter 422 from foreign objects. The liquid fertilizer then passes through two additional pressure gauges 424, 426. The additional pressure gauges 424, 426 are placed with the pressure regulator 420 in between so as to be able to monitor pressure and correct functioning of the system in the area of liquid flowing in a direction back towards the supply through the pressure regulator 420. In addition, the pressure gauges 424, 426 could be pressure sensors to provide direct feedback to the system.

The pressure regulator 420 is preferably a motorized relief valve modulated with a spring. This motorized relief valve offers quick adjustment to commands by the user or changes in pressure so as to regulate the system after the manner desired for the agricultural field's needs. The motorized relief valve provides numerous advantages over the use of traditional ball valves and other, similar valves. For example, including such a valve, which may be a pressure regulator that is modulated with a spring provides for incremental changes and increased speed to make any change to the system. With traditional ball valves, any change is slow, and it is difficult to make incremental changes in allowing a fluid to pass through. The pressure regulator 420 as shown and describes allows for near infinite change to the system in a quick manner to provide instantaneous feedback to the system. Still further, the pressure regulator 420 keeps the pressure as set by a user in a near-instantaneous manner by relieving or creating additional pressure through an opening in an incremental manner. This provides even greater control for the system and keeps the system at the pressure set by the user.

After the liquid fertilizer has traveled through the positive displacement pump 406, through the filtration device 412, and past the two pressure gauges 424, 426, the liquid fertilizer passes through a flowmeter 422. The flowmeter 422 is included to monitor the flow of the liquid fertilizer application system 400. According to at least some aspects of some embodiments, the flowmeter 422 is in place to control, automatically adjust, and measure aspects of the flow 300. As noted, the prior art utilizes flowmeters 422 to control the flow of a liquid fertilizer system, most often by fitting the flowmeter with an integrated flow control valve which controls output flow.

According to aspects of the invention however, flow is not what is controlled, it is system pressure that regulates the distribution of the liquid fertilizer. The flowmeter 422 is not controlling, rather just providing feedback. If the flow of the liquid fertilizer is at a dangerous or undesirable flow, this can trigger a response for the system to shut off the liquid distribution to the row units by using the row unit shutoffs 428. If the flowmeter 422 registers however that the flow is desirable and/or safe, the liquid fertilizer will continue to flow through the liquid fertilizer application system 400 passing through another pressure gauge 430, and then out through a dispensing apparatus in which the liquid fertilizer will be distributed out desirable positions from the row units 402.

Therefore, as understood from the present disclosure, the liquid fertilizer application system 400 provided includes providing and applying the liquid fertilizer at system level, and not just on a row-by-row basis. The motorized relief valve, shown to be a pressure regulator 420 modulated with a spring, responds quickly to changes, row control, and other updates that may be needed to the system. The modulation by spring is a significant improvement over the use of ball valves, which others have used to control the flow. As is known, ball valves are slow to react and are tougher to control the amount of product passing therethrough, especially when attempting to modulate in smaller increments. The use of the spring-modulated pressure regulator provides for a more nuanced control with precision and feedback.

Still further, the liquid fertilizer application system 400 can regulate pressure, not flow. The flow feedback from the flow meter 422 is used to aid in setting the system pressure and provides feedback to keep the system in a closed loop. However, it is the setting and maintenance of the system pressure for the liquid fertilizer application system 400 as shown and described that provides numerous advantages and improvements.

FIG. 18 shows another schematic drawing of the liquid fertilizer application system 400 for a rear trailer or hitch auxiliary tank option, with several additional components schematically shown. In particular, a tractor or trailer tank 432 and on-board tank 434 are both included in the option. An aux connection valve 436 controls flow of fluid to and from the tractor or trailer tank 432 and a rear fill valve 438 controls flow to and from the on board tank 434. Many additional aux valves 440 are included in the system so as to be able to control flow from the tractor or trailer tank 432 to the on-board tank 434 (near suction valve 442) and then onward to the flow meters and row units 402 via flowmeter transition valve 444. The suction valve 442 has a hole in the center that allows gas to flow through it to deactivate the cylinder when the valve is actuated. A pneumatically actuated plug is used to close or open the center hole. The flow meter transition valve 444 allows the user to block in, calibrate or verify calibration, replace instruments and vent entrapped pressure without shutting use of the row units 402 down. A rail pressure sensor 446 measures the pressure of fuel inside the rail.

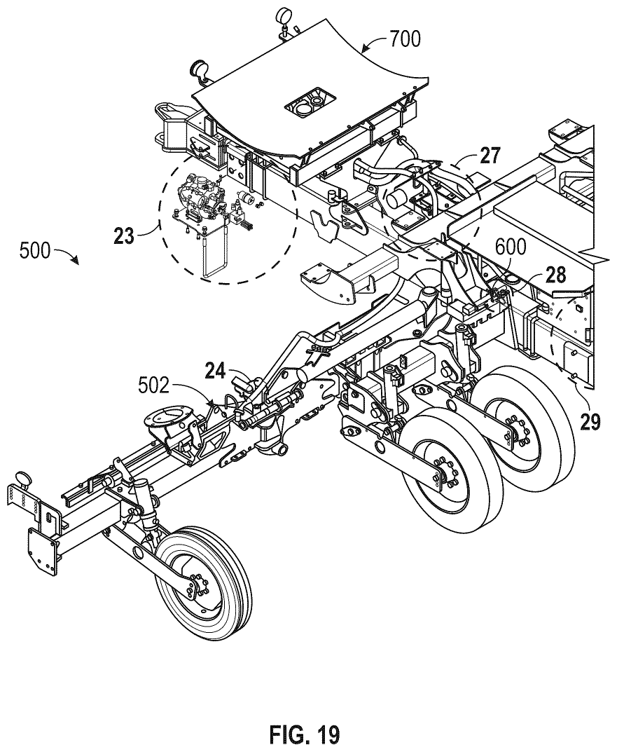

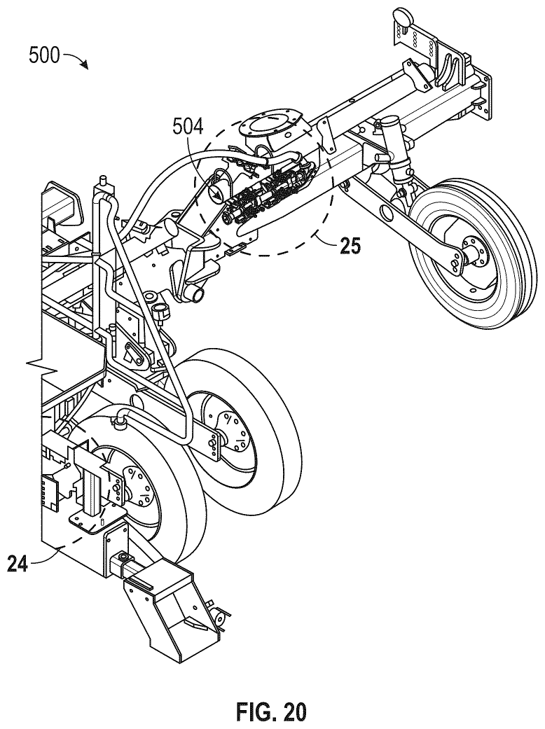

FIGS. 19-29 shows an example liquid fertilizer system 500. The liquid fertilizer system 500 includes a fertilizer manifold 600 and a fertilizer tank system 700, as shown in FIG. 19. FIGS. 19-20 show lefthand fertilizer mount bracket 502 and righthand fertilizer mount bracket 504.

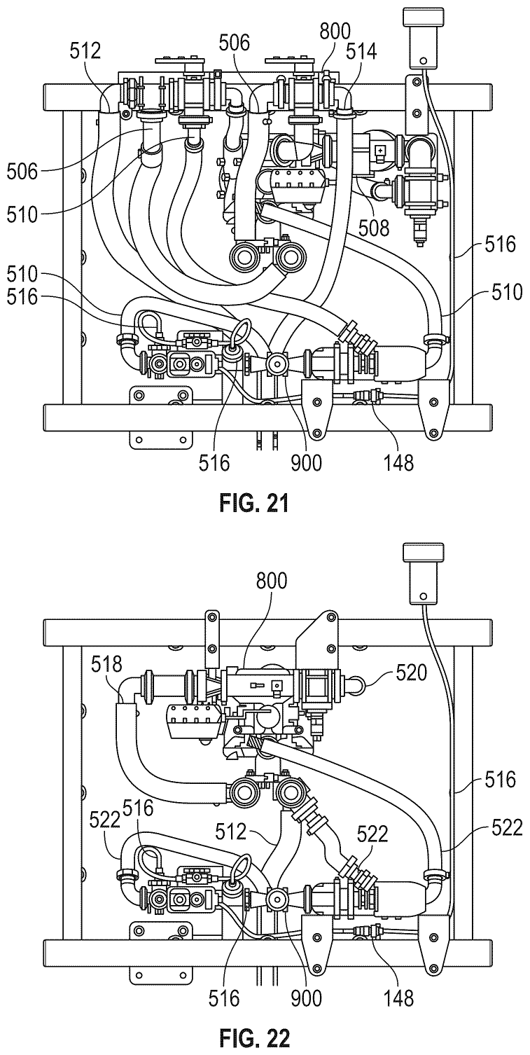

FIG. 21 shows that the liquid fertilizer system 500 also includes a fertilizer electric valve assembly 800, a flow meter assembly 900, and the orifice in-line housing assembly 148, which can be used on an agricultural implement 1000.

As shown in FIG. 21, the liquid fertilizer system 500 shows plumbing hose configurations, including first hoses 506, second hoses 508, third hoses 510, a bulk fill hose 512, an auxiliary hose 514, and a clear tube 516, to transport fertilizer fluid with the auxiliary option. As shown in FIG. 22, the liquid fertilizer system 500 shows plumbing hose configurations, including a bulk fill hose 512, a clear tube 516, fourth hoses 518, fifth hoses 520, sixth hoses 522, to transport fertilizer fluid without the auxiliary option.

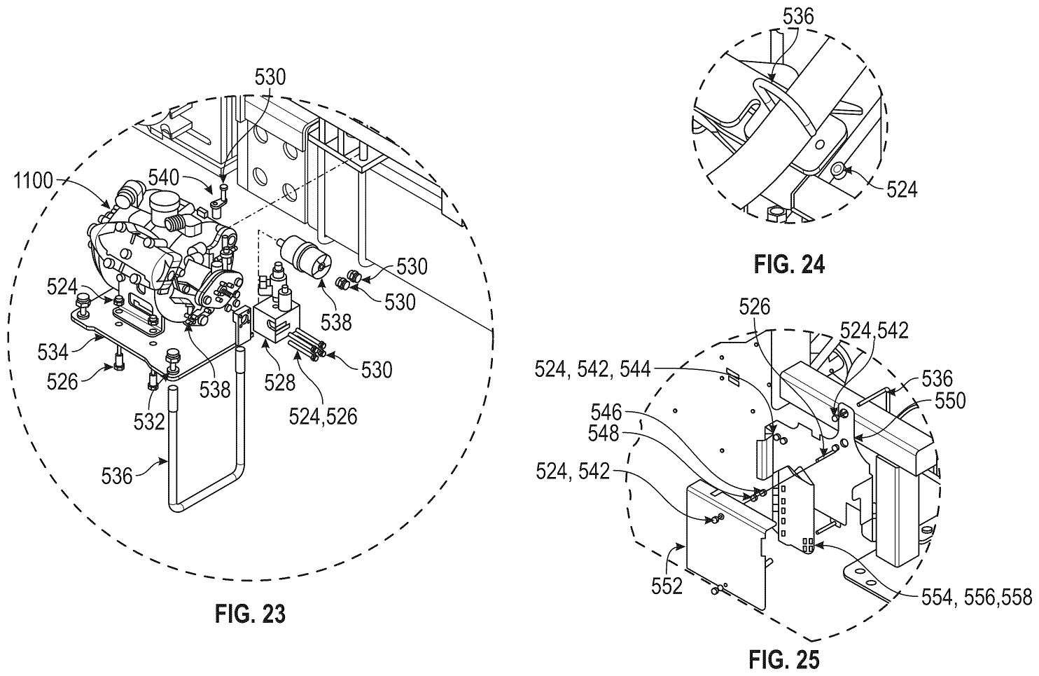

FIG. 23 shows that the liquid fertilizer system 500 also includes a diaphragm pump 1100 with a manifold fan control 528 and a hydraulic motor 538. To mount the diaphragm pump 1100 in place, a pump mount plate 534 is placed below the diaphragm pump 1100 and secured with lock nuts 524, hex head cap screws 526, a hex socket head cap screw 534, and a u-bolt 536 (also shown in FIG. 24). The manifold fan control 528 is secured in place (to the diaphragm pump 1100) with lock nuts 524, hex head cap screws 526, and connector with O-rings 530. The hydraulic motor 538 is secured to the manifold fan control 528 and diaphragm pump 1100 with connectors with O-rings 530.

FIG. 25 shows that the agricultural implement 1000 can also include IPN module assembly 554 and mounting hardware associated therewith. The IPN module assembly 554 is secured in place with the IPN mount 550 via a u-bolt 536, lock nuts 524, hex head cap screws 526, and washers 542. The IPN module assembly 554 is also secured to an IPN cover 552 with lock nuts 524, washers 542, a hex standoff 546, and a carriage bolt 548. An ethernet cable 558 plugs into the IPN module assembly 554 to allow computer components of the agricultural implement 1000, the liquid fertilizer system 500, and row units 402 to connect to a network.

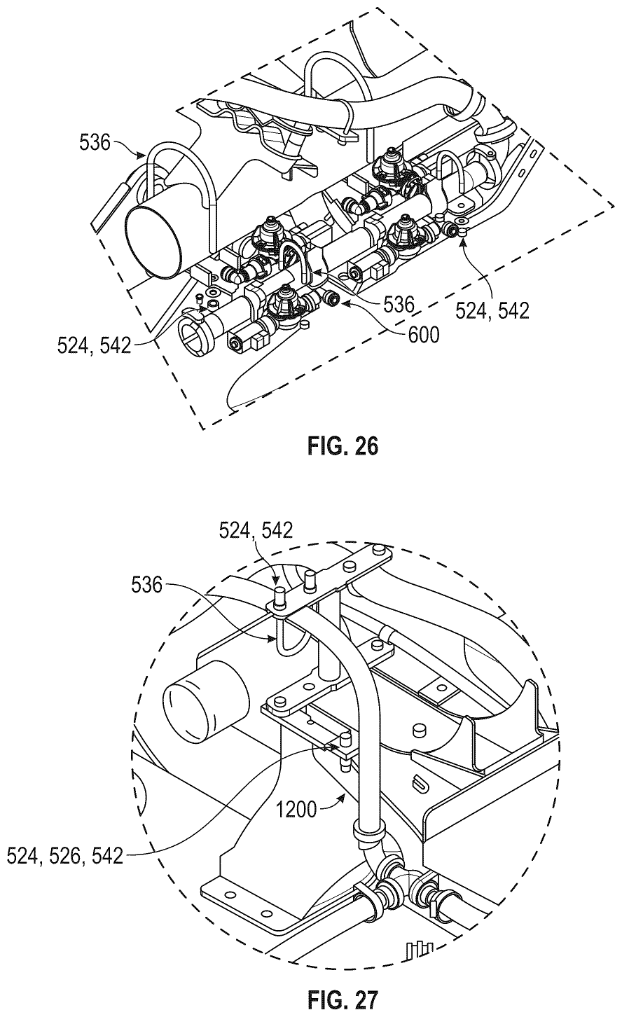

FIG. 26 emphasizes that the fertilizer manifold 600 mounts to and is secured in place within the liquid fertilizer system 500 via lock nuts 524, head cap screws 526, washers 542, and u-bolts 536.

FIG. 27 emphasizes that the liquid fertilizer system 500 also includes a fertilizer junction assembly 1200 that mounts to and is secured in place within the liquid fertilizer system 500 via lock nuts 524, head cap screws 526, washers 542, and u-bolts 536.

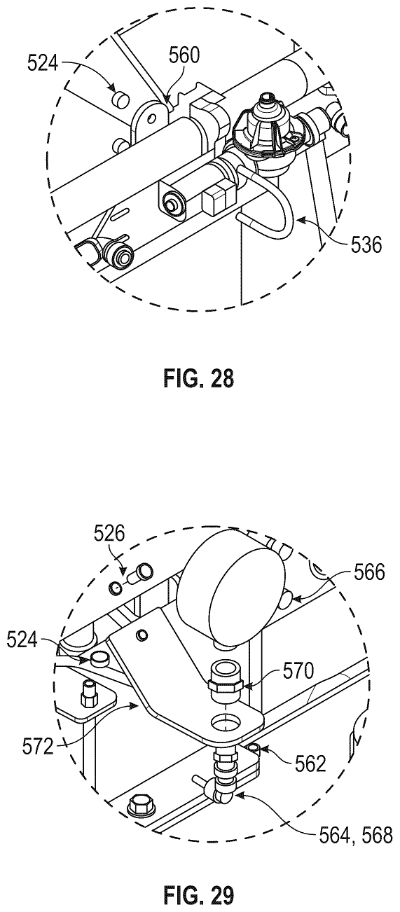

FIG. 28 shows a manifold mount for the fertilizer manifold 600 is secured with lock nuts 524 and a u-bolt 536.

FIG. 29 emphasizes view of the pressure gauge 566 of the liquid fertilizer system 500, which is secured in place using lock nuts 524, head cap screws 526, hex socket set screws 562, and a pressure gauge mount 572. A support tube 564 that passes through the pressure gauge mount 572 and a right-angle elbow 568 couple and directly support the pressure gauge 566 via coupling 570.

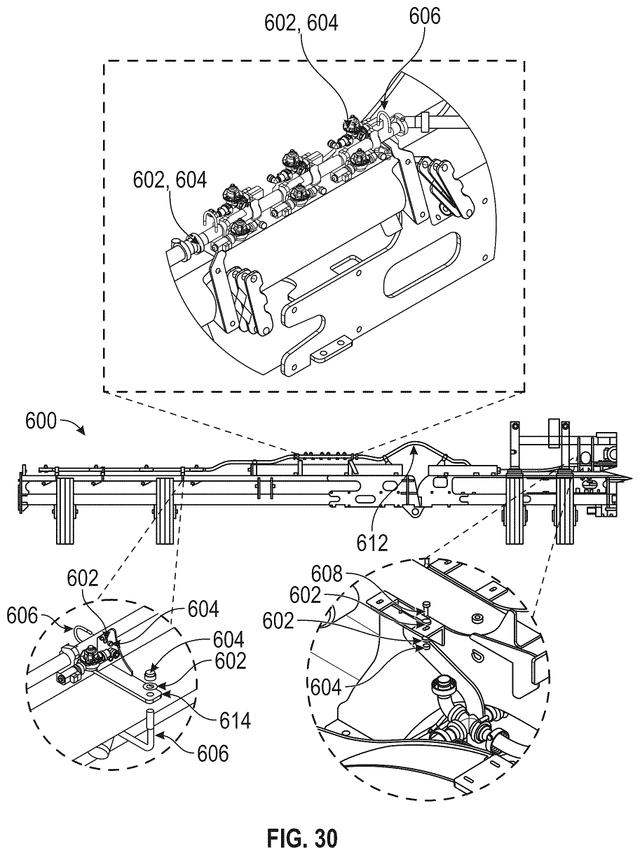

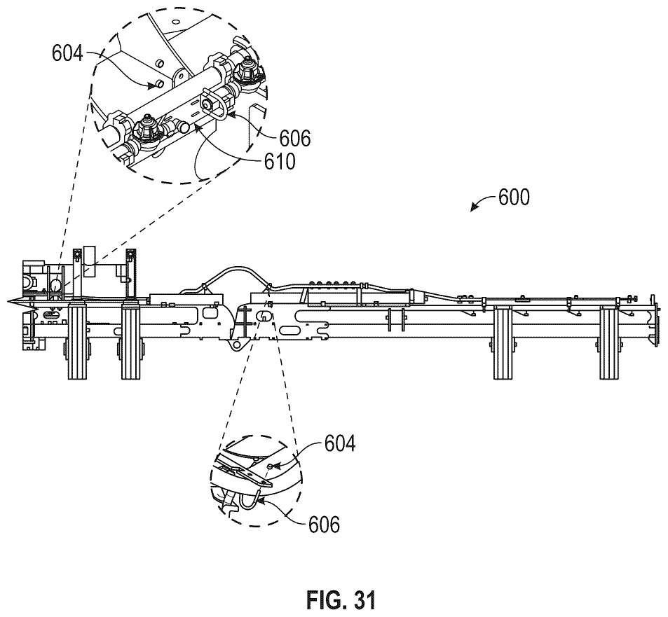

FIGS. 30-32 show aspects of the fertilizer manifold 600. As shown in FIGS. 30-31, the fertilizer manifold 600 is mounted with manifold mount 610 via washers 602, lock nuts 604, u-bolts 606, and hex head cap screws 608. A fertilizer tube mount 614 similarly utilizes washers 602, lock nuts 604, and u-bolts 606 to secure in place. A hose 612 carrying fertilizer fluid to row units throughout the toolbar is also shown. The fertilizer manifold 600 can also include, but is not limited to including, a flange clamp 616, a skirted flange gasket 618, a fertilizer manifold clamp with straight nozzle 620, a flanged fitting (e.g., 90° flanged fitting) 622, a flanged plug 624, a flanged barb 626, a flanged barb fitting 628 (e.g., 45° flanged fitting), a heavy duty hose clamp 630, fertilizer manifold sections 632, and an adapter 634.

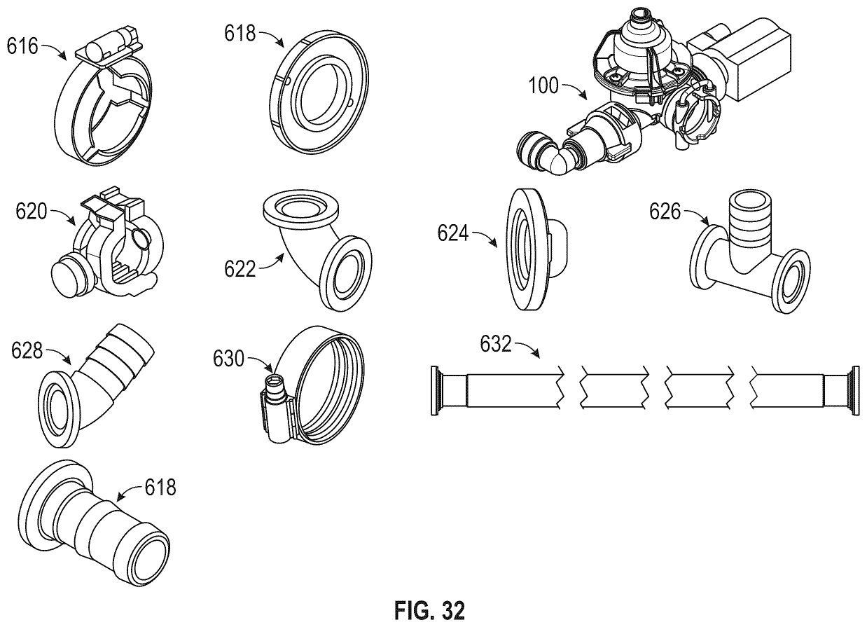

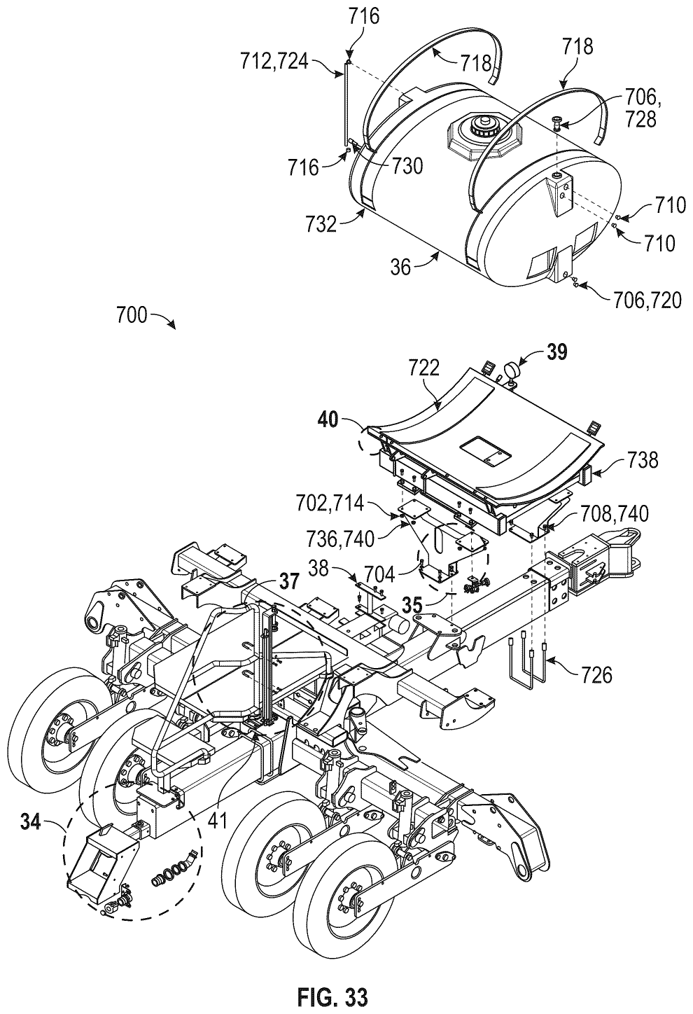

FIGS. 33-42 show a fertilizer tank system 700. As shown in FIG. 32, the fertilizer tank system 700 includes a fertilizer pressure gauge 701 that is connected directly to the fertilizer pressure manifold 600. The analog pressure gauge 701 is located on the front of liquid fertilizer tank 732. An output of the analog pressure gauge 701 can be visually viewed from a cab (e.g., a cab in a tractor) of the agricultural implement 1000.

As shown in FIG. 33, the fertilizer tank 732 is located at the top of the fertilizer tank system 700. The fertilizer tank 732 stores liquid fertilizer. The size of the fertilizer tank 732 is not limited herein, but is generally one of: a 400-gallon tank, a 500-gallon tank, and a 750-gallon tank. At the top of the fertilizer tank 732 there are two bands 718 at each side. At a first end of the fertilizer tank 732, a clear tube 724 comprising a hollow ball 712 includes two elbow 716 at a top and bottom end, which attaches to the top and bottom of the fertilizer tank 732. The clear tube 724 also includes a liquid level sensor 730. At a second end of the fertilizer tank 732, a hose clamp 706, hex pipe plugs 710, a barbed fitting 720, and an adapter 728 further secure the fertilizer tank 732 to a fertilizer tank base located therebeneath. A tank mount 738 includes edge trim protection 740 supports and is secured to the fertilizer tank base by way of u-bolts 726 and lock nuts 708.

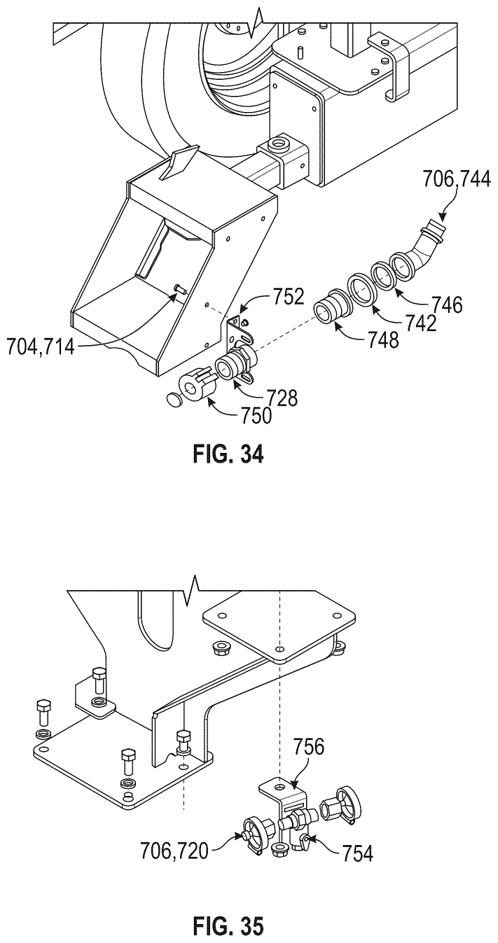

As shown in FIG. 34, the fertilizer fill valve mount bracket 752 attaches to the fertilizer tank system 700 with hex head cap screws 704 flange nuts 714. At a first side of the fertilizer fill valve mount bracket 752, an adapter 728 secures a dust cap 750 thereto. At a second side of the fertilizer fill valve mount bracket 752, a flange with male thread 748 attaches to a flange clamp 742, which attaches to a flange gasket 746, which attaches to hose clamp 706, which attaches to a flange with barb elbow 744.

As shown in FIG. 35, a three-way valve 754 and a site gauge bracket 756 attach to the rear support 736 the fertilizer tank system 700 through hose clamps 706 and barbed fittings 720.

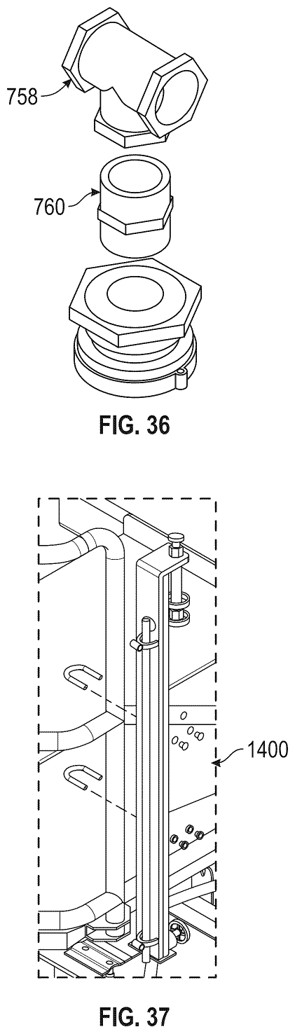

As shown in FIG. 36, the fluidic connection located at a bottom of the fertilizer tank 732 comprises a nipple 760 that separates into two separate fluidic streams by way of a tec 758 directly attached to said nipple 760.

As shown in FIG. 37, a fertilizer level sight assembly 1400 is shown attaching to a toolbar 1018, 1032, 1035 of the agricultural implement 1000.

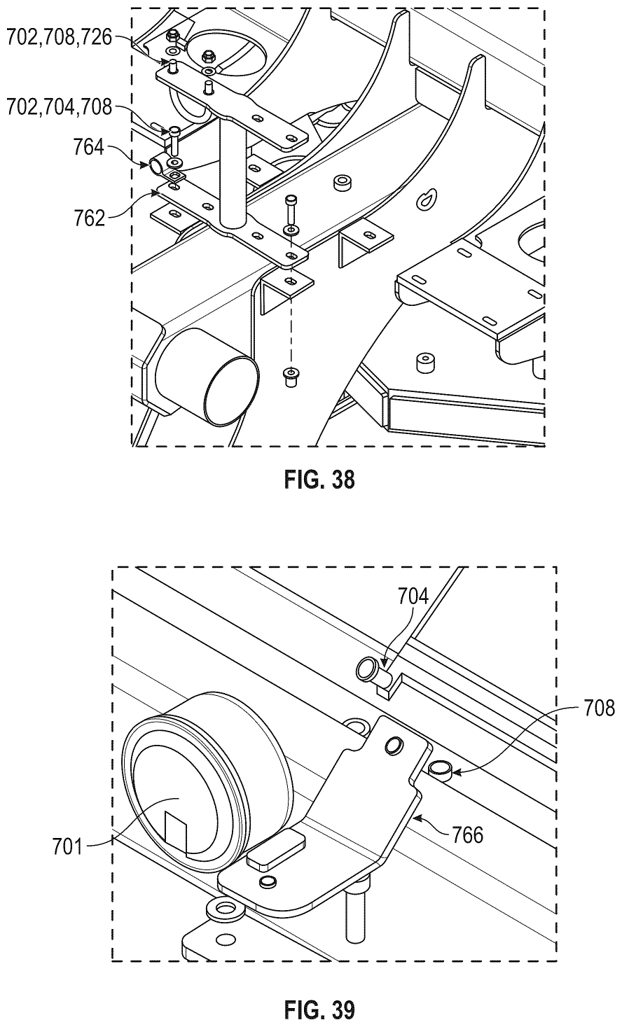

As shown in FIG. 38, a support 762 and an insulated clamp 764 for the fertilizer tank base and tank pad 722 secure to with washers 702, hex head cap screws 704, and lock nuts 708.

As shown in FIG. 39, the pressure gauge mount 766 allows the fertilizer pressure gauge 701 to attach to the fertilizer tank base at a first end of the tank pad 722, which supports and holds the fertilizer tank 732.

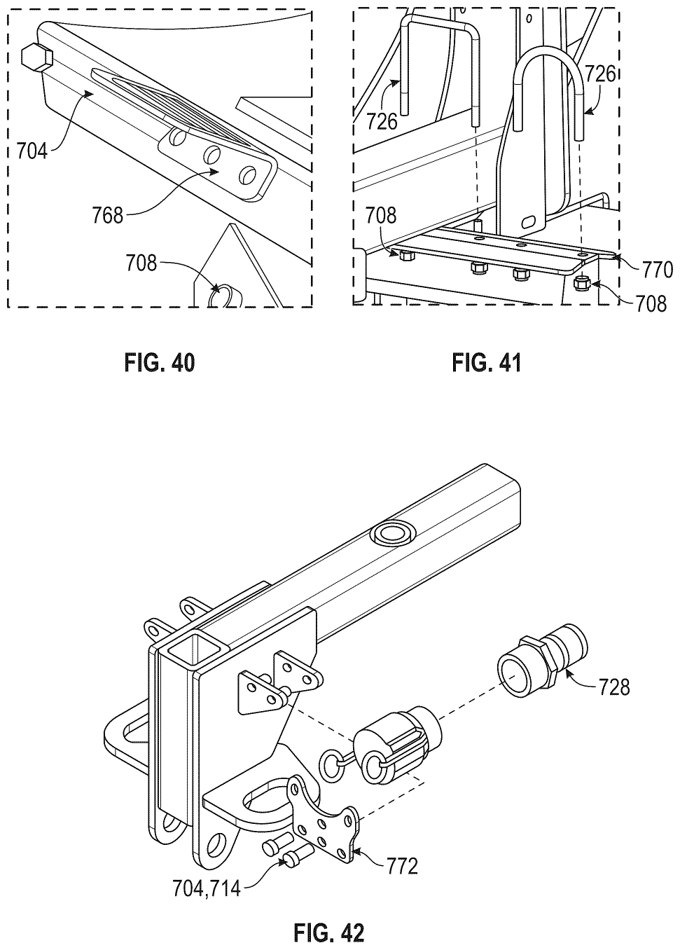

As shown in FIG. 40, an anchor 768 is included at the other end of the tank pad 722 and fertilizer tank base, which supports and holds the fertilizer tank 732. The anchor 768 is secured with hex head cap screws 704 and lock nuts 708.

As shown in FIG. 41, the fertilizer tube support bracket 770 secures to the anchor 768 with u-bolts 726 and lock nuts 708.

As shown in FIG. 42, the fertilizer tank system 700 can be adapted for a rear trailer hitch by way of an adapter 728. The adapter 728 attaches directly to a fertilizer fill valve mount plate 772 with hex head cap screws 704 and flange nuts 714.

A fluid switch and liquid level sensor 730 indicate whether there is power to the fertilizer tank system 700 and whether fluid is present. A green light can indicate there is power, while an orange can indicate there is fluid present.

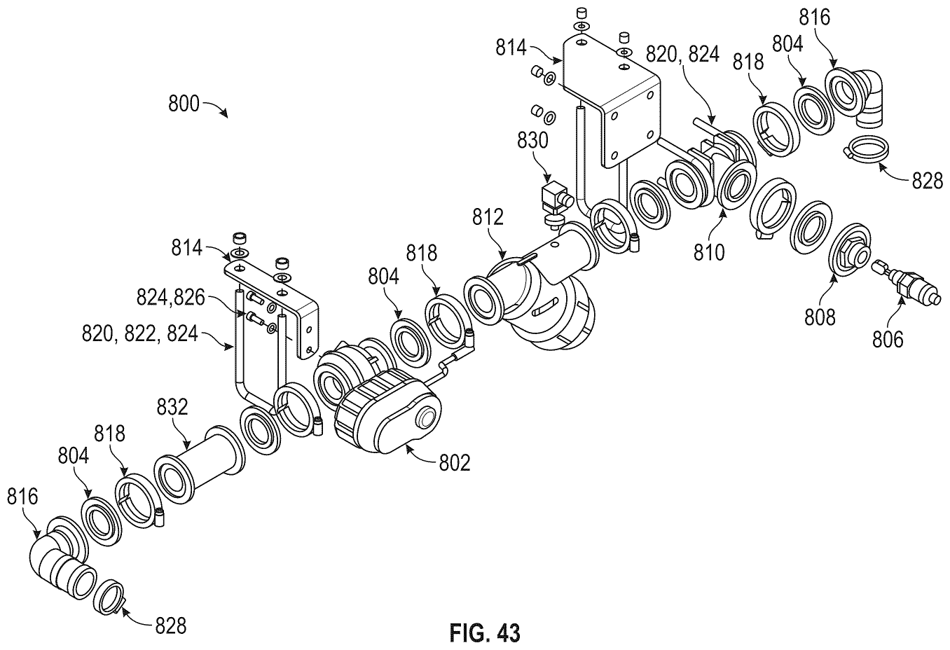

FIG. 43 shows a fertilizer electric valve assembly 800, which is included in the liquid fertilizer system 500 (FIG. 21). The electric valve assembly 800 comprises an electric ball valve assembly 802, a liquid level sensor 806, a tee 810, a manifold Y-strainer 812, a plumbing bracket 814, elbows 816, a hydraulic pressure transmitter sensor 830, and a coupling 832.

As shown in FIG. 43, and at a first end of the fertilizer electric valve assembly 800, a first hose clamp 828 attaches at a first end of a first elbow 816. Upstream of the first elbow 816, the first elbow 816 fluidly connects to one of the auxiliary hose 514 (FIG. 21), the second hoses 508 (FIG. 21), or one of the fifth hoses 520 (FIG. 22). Downstream of the first elbow 816, the first elbow 816 fluidly connects to the tee 810 by way of a skirted flange gasket 804 and a flange clamp 818. Upstream of the tee 810, and fluidly parallel to the first elbow 816, the tec 810 also fluidly connects to the liquid level sensor 806 by way of a plug 808, another skirted flange gasket 804, and another flange clamp 818. Further downstream of the tec 810, the tec 810 also connects to the manifold Y-strainer 812 by way of a skirted flange gasket 804 and a flange clamp 818.

As shown in FIG. 43, and at a second end of the fertilizer electric valve assembly 800, a second hose clamp 828 attaches at a first end of a second elbow 816. Upstream of the second elbow 816, the second elbow 816 fluidly connects to one of the first hoses 506 (FIG. 21), the bulk fill hose 512 (FIG. 21), or one of the fourth hoses 518 (FIG. 22). Downstream of the second elbow 816, the second elbow 816 fluidly connects to the coupling 832 by way of another skirted flange gasket 804 and another flange clamp 818. Downstream of the coupling 832, the coupling 832 fluidly connects to the electric ball valve assembly 802 by way of another skirted flange gasket 804 and another flange clamp 818. Downstream of the electric ball valve assembly 802, fluidly the electric ball valve assembly 802 connects to the manifold Y-strainer 812 by way of another skirted flange gasket 804 and another flange clamp 818.

A first plumbing bracket 814 mounts the electric valve assembly 800 to the rest of the liquid fertilizer system 500. The tec 810 attaches to the first plumbing bracket 814 by way of u-bolts 820, lock nuts 822, and washers 824. The first plumbing bracket 814 attaches to a rectangular bar of the rest of the liquid fertilizer system 500 (FIG. 21) by way of a u-bolt 820, lock nuts 822, and washers 824. The tee 810 secures to said rectangular bar with a u-bolt 820 and washers 824.

A second plumbing bracket 814 mounts the electric valve assembly 800 to the rest of the liquid fertilizer system 500. The electric ball valve assembly 802 attaches to a second plumbing bracket 814 by way of washers 824 and hex head cap screws 826. The second plumbing bracket 814 attaches to a rectangular bar of the rest of the liquid fertilizer system 500 (FIG. 21) by way of a u-bolt 820, lock nuts 822, and washers 824. The tee 810 secures to said rectangular bar with a u-bolt 820 and washers 824.

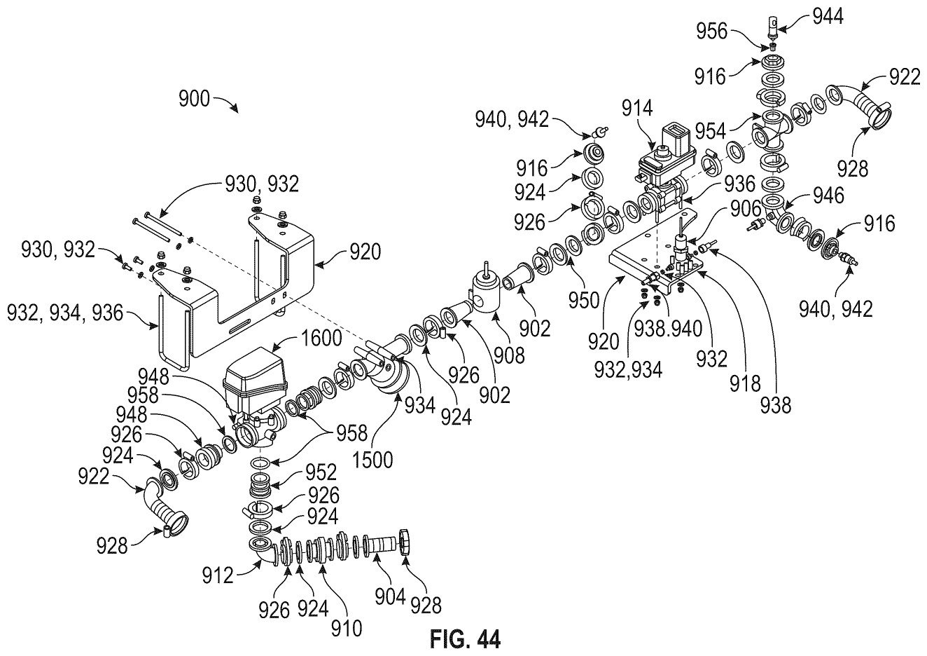

FIG. 44 shows a flow meter assembly 900, which includes a flow meter flanged adapter 902, an adapter flange with hose barb 904, a mini flow meter sensor 906, a flow meter 908, a manifold flanged check valve 910, a flanged fitting 912, an electric ball valve with harness 914, a flanged plug 916, a mini flow meter 918, a support tube 940, a pressure sensor 944, an elbow with gauge port flange sweep 946, a manifold Y strainer assembly 1500, and a pressure regulator 1600.

At one end of the flow meter assembly 900, a heavy duty hose clamp 928 attaches a first flange with a barb 922 to one of the third hoses 510 (FIG. 21) or sixth hoses 522 (FIG. 22). Downstream of the first flange with a barb 922, the first flange with a barb 922 is fluidly connected to a first male hose fitting with clamp coupling 952 by way of a skirted flange gasket 924 and a flange clamp 926. Downstream of the first male hose fitting with clamp coupling 952, the second male hose fitting with clamp coupling 952 fluidly connects to the pressure regulator 1600 by way of a hex nut 948 and an O-ring 958. Upstream of the pressure regulator 1600 and fluidly parallel to the first flange with a barb 922, another heavy duty hose clamp 928 attaches an adapter flange with hose barb 904 to one of the one of the third hoses 510 (FIG. 21) or sixth hoses 522 (FIG. 22). Downstream of the adapter flange with hose barb 904, the adapter flange with hose barb 904 fluidly connects to a manifold flanged check valve 910 by way of another skirted flange gasket 924 and another flange clamp 926. Downstream of the adapter flange with hose barb 910, the adapter flange with hose barb 910 fluidly connects to a flanged fitting 912, which is similar to an elbow, by way of another skirted flange gasket 924 and another flange clamp 926. Downstream of the flanged fitting 912, the flanged fitting 912 fluidly connects to a second male hose fitting with clamp coupling 952, by way of another skirted flange gasket 924 and another flange clamp 926. Downstream of the second male hose fitting with clamp coupling 952, the second male hose fitting with clamp coupling 952 fluidly connects to the pressure regulator 1600 by way of another hex nut 948 and another O-ring 958. Downstream of the pressure regulator 1600, the pressure regulator 1600 fluidly connects to a third male hose fitting with clamp coupling 952 by way of another hex nut 948 and another O-ring 958. Downstream of the third male hose fitting with clamp coupling 952, the third male hose fitting with clamp coupling 952 fluidly connects to the manifold Y strainer assembly 1500 by way of another skirted flange gasket 924 and another flange clamp 926.

The pressure regulator 1600 controls delivery manifold pressure and bypasses overhead flow for agitation. As shown in FIG. 44, a plumbing bracket 920 mounts the flow meter assembly 900 and the pressure regulator 1600 to the rest of the liquid fertilizer system 500 by way of hex head cap screws 930, washers 932, lock nuts 934, and u-bolts 936.

At the other one end of the flow meter assembly 900, a heavy duty hose clamp 928 attaches a first flange with a barb 922 to one of the third hoses 510 (FIG. 21) or sixth hoses 522 (FIG. 22). Downstream of the second flange with a barb 922, the second flange with a barb 922 is fluidly connected to a flanged poly cross 952 by way of a skirted flange gasket 924 and a flange clamp 926. Upstream of the flanged poly cross 952 and fluidly parallel to the second flange with a barb 922, a pressure sensor 944 attached to a reducer 956 and a flanged plug 916 fluidly connect to the flanged poly cross 952 by way of a skirted flange gasket 924 and a flange clamp 926. Upstream of the flanged poly cross 952 and fluidly parallel to the second flange with a barb 922 and the pressure sensor 956, a first support tube 940 and a first connector 942 attached to another flanged plug 916 fluidly connect to an elbow with gauge port flange sweep 946 by way of another skirted flange gasket 924 and another flange clamp 926. The elbow with gauge port flange sweep 946 is also attached to a second support tube 940 and a second connector 942. Downstream of the elbow with gauge port flange sweep 946, the elbow with gauge port flange sweep 946 fluidly connects to the flanged poly cross 952 by way of another skirted flange gasket 924 and another flange clamp 926. Downstream of the flanged poly cross 952, the flanged poly cross 952 fluidly connects to an electric ball valve with harness 914 by way of another skirted flange gasket 924 and another flange clamp 926. The electric ball valve with harness 914 is functionally attached to a mini flowmeter 918 and a push to connect adapter 938.

The electric ball valve with harness 914 closes to send flow through a mini flowmeter 918 at low flow rates. The mini flowmeter 918 includes a small flow meter sensor and arrows that indicate direction of flow. As shown in FIG. 44, another plumbing bracket 920 mounts the electric ball valve with harness 914 and the mini flowmeter 918 to the rest of the liquid fertilizer system 500 by way of hex head cap screws 930, washers 932, lock nuts 934, and u-bolts 936.

Downstream of the electric ball valve with harness 914, the electric ball valve with harness 914 fluidly connects to a flanged tee 950 by way of another skirted flange gasket 924 and another flange clamp 926. Upstream of the flanged tee 950 and fluidly parallel to the electric ball valve with harness 914, a third support tube 940 and a third connector 942 attached to another flanged plug 916 fluidly connect to the flanged tee 950 by way of another skirted flange gasket 924 and another flange clamp 926. Downstream of the flanged tee 950, the flanged tec 950 fluidly connects to a flow meter 908 by way of a first flow meter flanged adapter 902 and another skirted flange gasket 924 and another flange clamp 926. The flow meter 908 is a full flow meter system. Downstream of the flow meter 908, the flow meter 908 fluidly connects to the manifold Y strainer assembly 1500 by way of a second flow meter flanged adapter 902 and another skirted flange gasket 924 and another flange clamp 926.

The flow meter 908 is preferably horizontal during operation. When the planter toolbar 1018, 1032, 1035 is on level ground, the flow meter 908 can be brought to a horizontal orientation by adjusting the rotating manifolds.

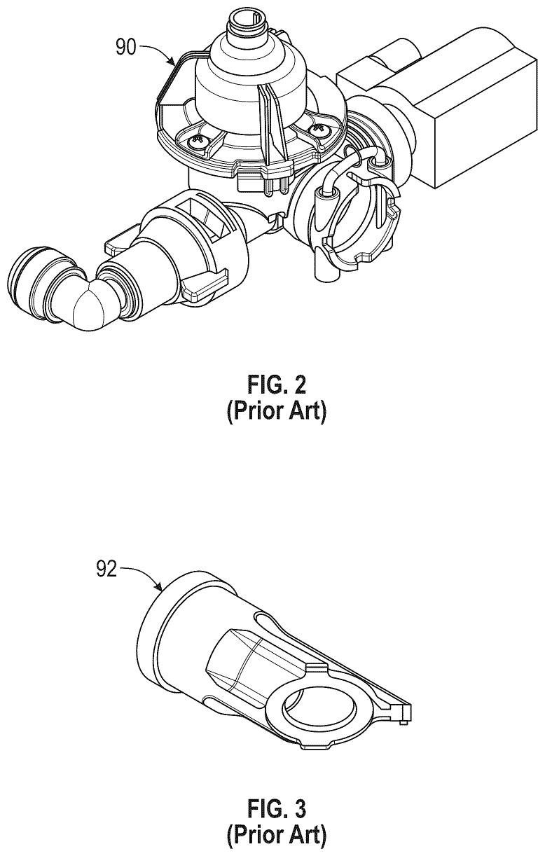

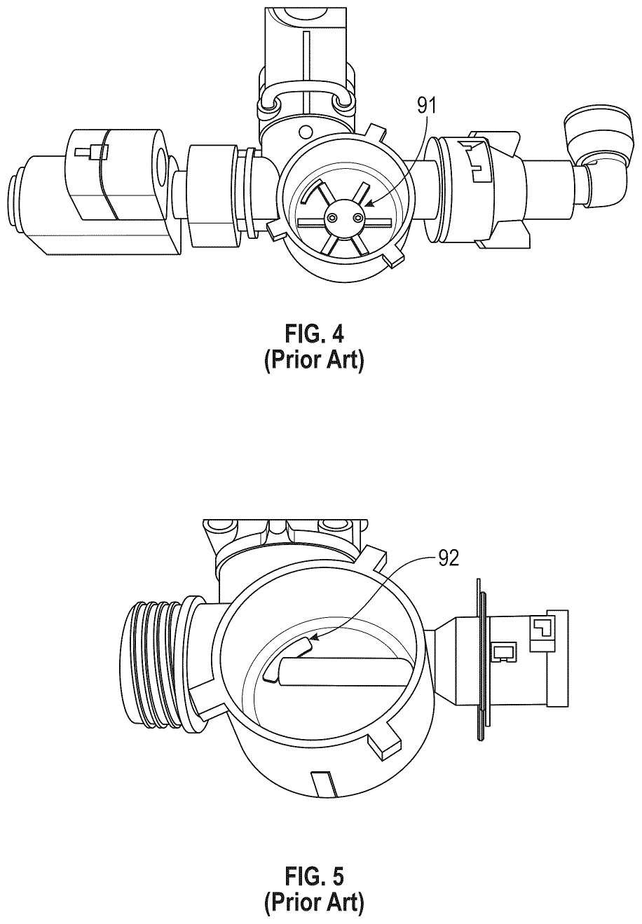

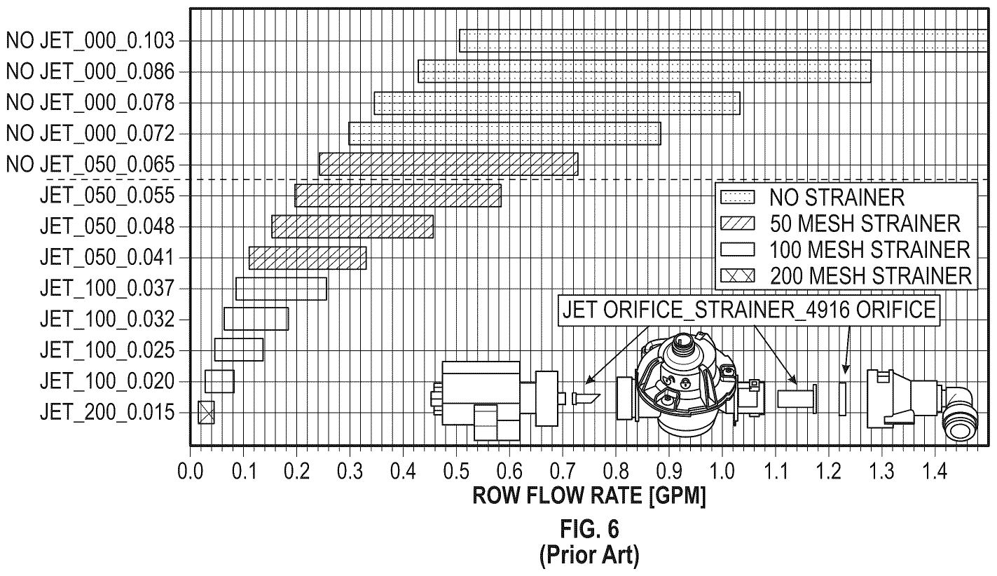

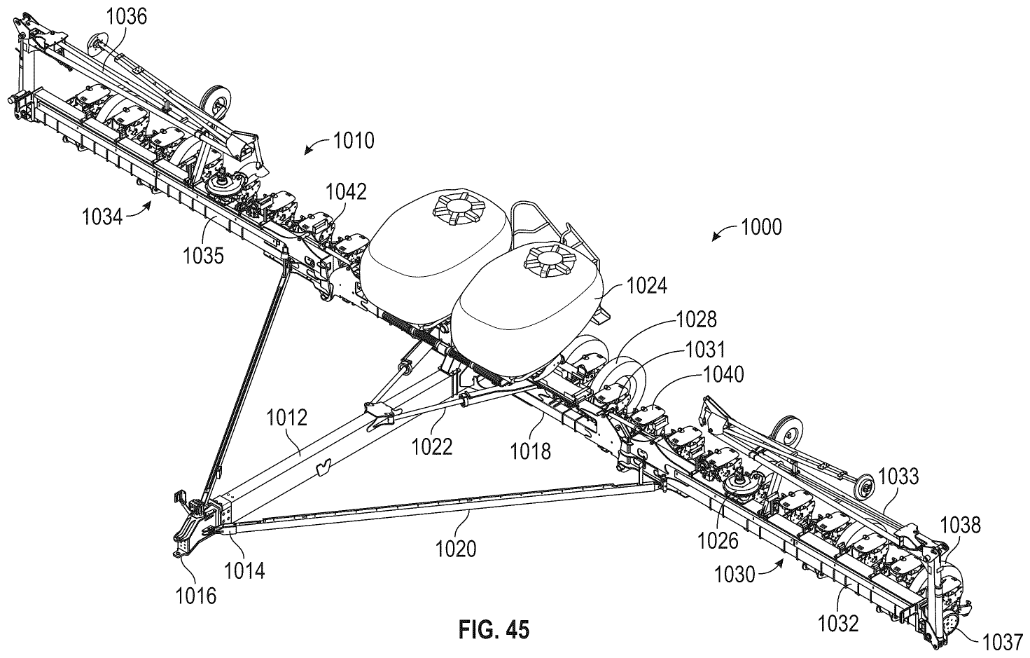

FIG. 45 shows an agricultural implement 1000, which in this instance is the planter 1010 used to plant and fertilize seed in a controlled manner. For example, the planter 1010 as shown in FIG. 2 includes a tongue 1012, preferably telescoping. The tongue 1012 includes a first end 1014 with an implement hitch 1016 for attaching to a tow vehicle, such as a tractor. The opposite end of the tongue 1012 is attached to a frame or central toolbar 1018. Draft links 1020 are connected between the central toolbar 1018 and the tongue 1012 and are used in conjunction with folding actuators 1022 to fold the central toolbar 1018 in a frontward manner. Therefore, the tongue 1012 may be a telescoping tongue in that it can extend or track to allow for the front folding of the central toolbar 1018. The central toolbar 1018 includes first and second wings 1030, 1034 extending therefrom. The central toolbar 1018 includes central hoppers 1024 which contain seed or other granules used with planting. A plurality of transport wheels 1028 also are connected to the central toolbar 1018. The first and second wings 1030, 1034 are generally mere images of one another. The wings include first and second wing toolbars 1032, 1035. Attached along the central toolbar 1018 as well as the first and second wing toolbar 1032, 1035, are a plurality of row units 1040. The row units include seed meters 1042 and/or other components used for planting and fertilizing seed in a controlled manner. Also connected to the first and second wings 1030, 1034 are first and second markers 1033, 1036. The markers include actuators 1037 which are used to raise and lower the markers 1033, 1036. The markers 1033, 1036 can be lowered to provide guidance for the edge of a planter for use in planting. When not required, the markers can be lifted to a position as that shown in FIG. 45 to move the markers out of the way.

Also shown in FIG. 45 are a plurality of fans 1026 as well as a plurality of wheels 1038. The wings may also include actuators 1031 to raise and lower or otherwise provide a downward force on the wings. Therefore, as is shown in FIG. 45, there are a multiplicity of components of the planting implement 1010. The components may include moving parts, such as the actuators used to move the wings, markers, row units, etc., while also providing additional functions. For example, the fans 1026 are used to provide a pressure in the seed meters 1042 to aid in adhering seed to a seed disk moving therein. The seed meters may be electrically driven in that a motor, such as a stepper motor, can be used to rotate the seed meters to aid in adhering seed thereto and to provide for dispensing of the seed in a controlled manner for ideal spacing, population, and/or placement. Other features may include actuators or other mechanisms for providing down force to the row units 1040. Lights may also be included as part of the planter. Finally, an air seed delivery system may be provided between the central hoppers 1024 and any plurality of seed meters 1042 on the row units 1040 in that the air seed delivery system provides a continued flow of seed to the row units on an as needed manner to allow for the continuous planting of the seed via the seed meters on the row units. Thus, the various controls of the planter may require or otherwise be aided by the use of an implement control system. The implement control system can aid in controlling each of the functions of the implement or planter 1010 so as to allow for the seamless or near seamless operation with the implement, and also provides for the communication and/or transmission of data, status, and other information between the components.

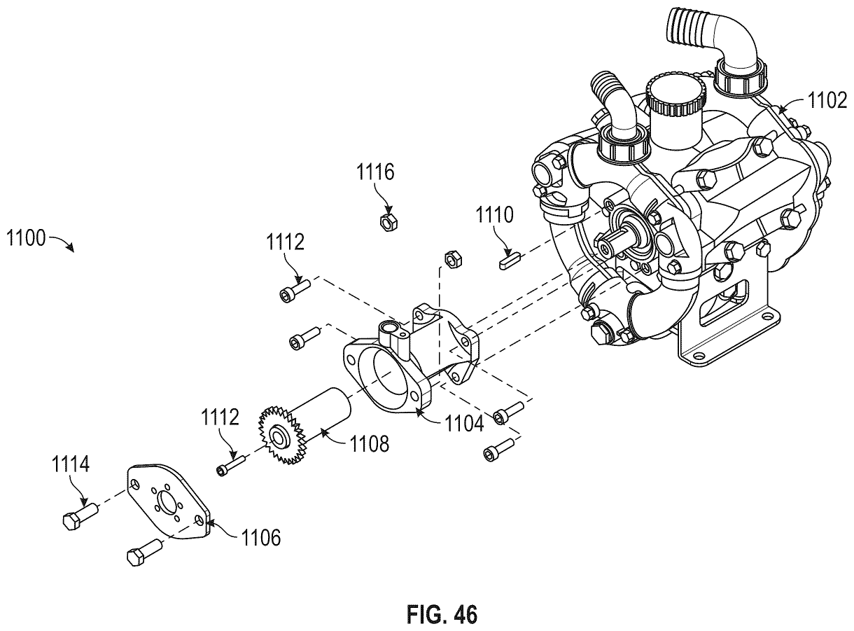

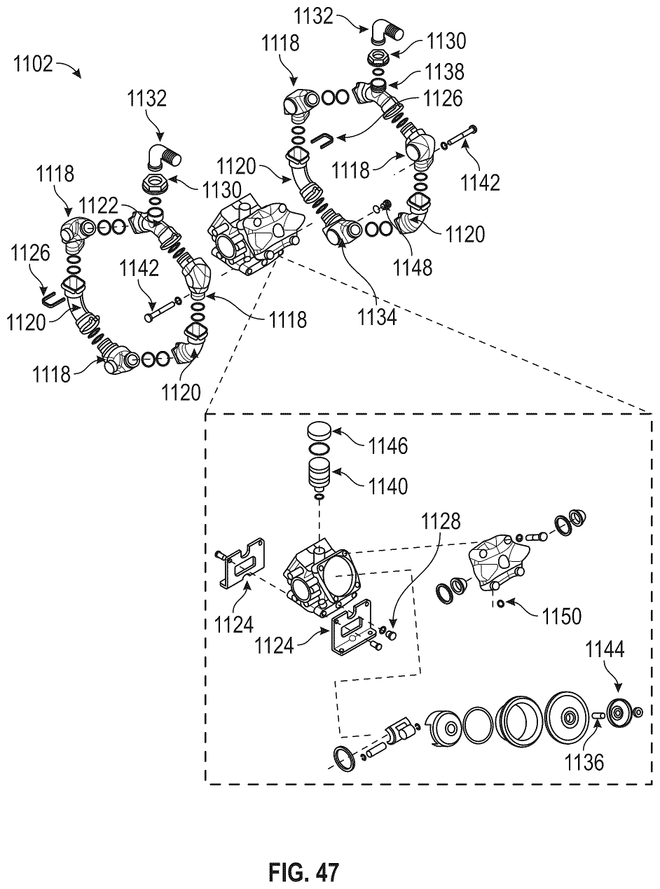

FIGS. 46-47 show a diaphragm pump 1100 and diaphragm pump assembly 1102. The diaphragm pump 1100 is a is a positive displacement pump uses reciprocating movement of a diaphragm to expand and compress volumes of fluids.

As shown in FIG. 46, the diaphragm pump comprises a flange hydraulic motor 1104 with a coupler with hall effect wheel 1108 located therewithin, which is mounted to the diaphragm pump assembly 1102 with hex socket head cap screws 1112 and hex locknuts 1116. The coupler with hall effect wheel 1108 is secured with a hex socket head cap screw 1112 to a central shaft along the rest of the diaphragm pump assembly 1102 so that they are aligned along a common central axis. A flange hydraulic motor mount 1106 covers the flange hydraulic motor 1104 and the coupler with hall effect wheel 1108. The flange hydraulic motor mount 1106 utilizes hex head cap screws 1114 and to further secure all of the components of the diaphragm pump 1100 in place.

As shown in FIG. 47, the forward end of the diaphragm pump 1100 comprises a first, first manifold section 1118; a first, second manifold section 1120; a second, first manifold section 1118; a second, second manifold section 1120; a third, first manifold section 1118, and a third manifold section 1122, each fluidly connected to one another along an annular ring. The third manifold section functions as a tee section and is fluidly connected to a forward hose barb 1132, which functions as an elbow, by way of a ring nut 1130.

As shown in FIG. 47, the rearward end of the diaphragm pump 1100 comprises a fourth, first manifold section 1118; a third, second manifold section 1120; a fourth manifold section 1134; a fourth, second manifold section 1120; a fifth, first manifold section 1118, and a fifth manifold section 1138, each fluidly connected to one another along an annular ring in said order. The third manifold section functions as a tec section and is fluidly connected to a rearward hose barb 1132, which functions as an elbow, by way of a ring nut 1130.

As shown in FIG. 47, the rest of the diaphragm pump assembly 1102 comprises internal pump components that can be seen toward the bottom of the figure. The internal components are secured in place with two foot mounts 1124 and are hermetically sealed from the rest of the diaphragm pump assembly 1102 with oil drain plugs 1128 and a square plug 1150, said guts comprising a hub pin 1136 and a diaphragm plate 1144. A tank sight glass 1140 allows view into the diaphragm pump's internal components without having to open up the diaphragm pump 1100. The tank sight glass 1140 is protected by the sight glass cap 1146.

The mechanical work and change in volumes causes the transfer of fluid. Other positive displacement pumps could be used in lieu of the diaphragm pump 1100, however the diaphragm pump 1100 is particularly beneficial because of the presence of a flexible separating component (the diaphragm) between mechanical parts and pumped liquid circuit. This enables the diaphragm pump 1100 to transfer liquids which would be detrimental to other types of reciprocating pumps. Pistons are generally in a boxer type opposing cylinder arrangement, or in a radial layout around the axis of the crankshaft which drives them.

The piston is mechanically connected to the diaphragm. The diaphragm is mechanically operated by the piston at a center and at the same time an outer edge of the diaphragm, which ensures a watertight seal around the pumping chamber. In a “semi-hydraulic diaphragm pump”, the diaphragm is rigidly secured to the piston by a stud screwed on the piston and a plate tightened by a nut. In a hydraulic diaphragm pump the center of the diaphragm is fixed to a floating component on piston. The suction and delivery valves, fitted at the pumping chamber suction and delivery ports, are operated by the alternating negative and positive pressure inside circuit.

During the suction stroke (piston retreating), the difference between the suction pressure and the pressure inside the pump head open the suction valve and closes the delivery valve. The transferred liquid is drawn into the head by the suction line.

During the compression stroke (advancing piston), the suction valve closes and the delivery valve opens due the pressure generated inside the head by the piston. The transferred liquid is pumped out of the head and into the delivery line.

When the diaphragm pump 1100 is new, oil in the tank is clear and yellowish in color. After a few operating hours, the oil in the tank loses its transparency and becomes dark due to metal particles removed by rubbing of internal components during functioning. This is the normal color for this type of diaphragm pump. This occurs regardless of the type of oil used and the pump's working conditions. In heavy-duty working conditions, oil will become dark more quickly. When oil in the tank becomes light grey and looks milky (color also depends on color of the liquid being pumped), operation of the pump should be ceased as one or more of the diaphragms has ruptured, allowing the aqueous solution pumped to pass into the lubricating oil and form a water/oil emulsion inside pump body.

Aside from its lubricating function, in diaphragm pumps the oil passes through the calibrated holes in the sleeves uncovered at every piston stroke to forma protective cushion between piston and diaphragm. The volume of this oil cushion is not constant; it varies with pressure/vacuum inside pumping chamber. However, the oil cushion is only effective when it does not contain residual air. After replacing diaphragms the oil cushion should be restored, by removing as much air as possible inside the body and specifically between pistons and diaphragms.

To restore the oil cushion, calibrated holes in the sleeves should be mounted in the vertical position, allowing air to flow out, and the cap should be off of the tank. Before proceeding, the appropriate quantity of oil can be weighed. The pump shaft can then be turned by hand and tiled at various angles; air bubbles can be seen coming out of the tank.

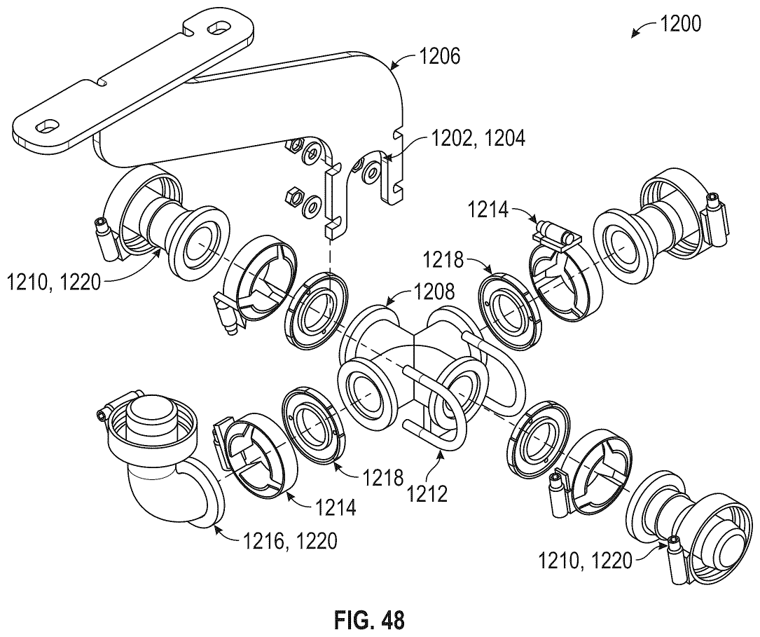

FIG. 48 shows a fertilizer junction assembly 1200. The fertilizer junction assembly 1200 includes a mounting bracket 1206 that mounts said fertilizer junction assembly 1200 to the rest of the liquid fertilizer system 500 (FIG. 27), by way of washers 1202, lock nuts 1206, and u-bolts 1212. Four heavy duty hose clamp 1220 fluidly connect each end of the fertilizer junction assembly 1200 to the rest of the liquid fertilizer system 500.

At the center of the fertilizer junction assembly 1200, there is a flanged poly cross 1208. Upstream of the flanged poly cross 1208, a flange with barb 1216 is fluidly connected to the flanged poly cross 1208 by way of a flange clamp 1214 and a skirted flange gasket 1218. Downstream of the flanged poly cross 1208, and opposite the flange with barb 1216, the flange poly cross 1208 fluidly connects to a first adapter flange with hose barb 1210 by way of another flange clamp 1214 and another skirted flange gasket 1218. Upstream of the flanged poly cross 1208, and fluidly parallel to the flange with barb 1216, the flange poly cross 1208 fluidly connects to a first adapter flange with hose barb 1210 by way of another flange clamp 1214 and another skirted flange gasket 1218. Downstream of the flanged poly cross 1208, and opposite first adapter flange with hose barb 1210, the flange poly cross 1208 fluidly connects to a third adapter flange with hose barb 1210 by way of another flange clamp 1214 and another skirted flange gasket 1218.

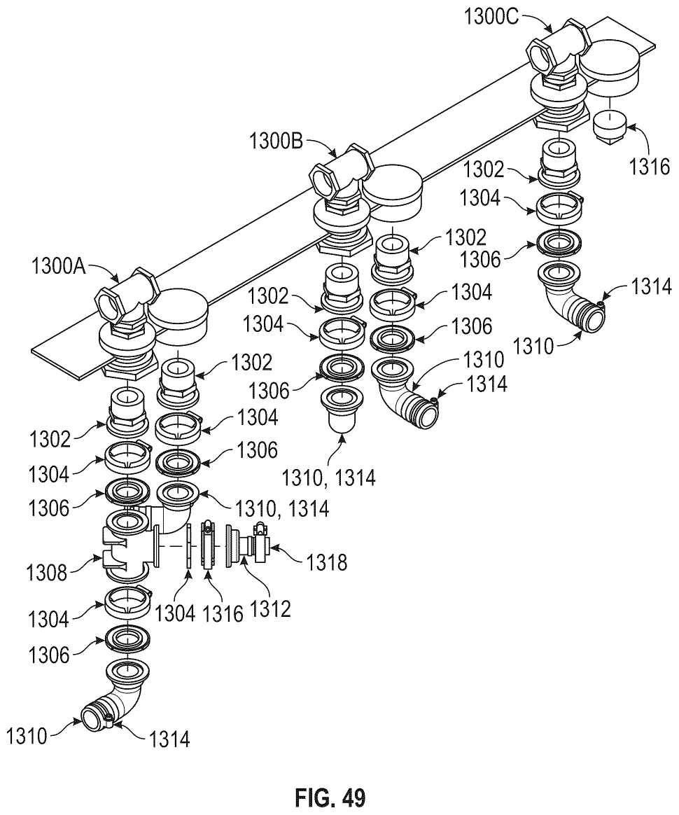

FIG. 49 show tank port assemblies 1300, including the non-aux valve option tank port assembly 1300A, the aux valve option tank port assembly 1300B, and the liquid fertilizer tank only tank port assembly 1300C. Hose clamps 1314 are located at all downstream locations of the tank port assemblies 1300.

The non-aux valve option tank port assembly 1300A includes a first subassembly that includes a first flange with male thread 1302, a first flange clamp 1304, a first skirted flange gasket 1306, a tee, port flange 1308, a second flange clamp 1304, a second skirted flange gasket 1306, and an elbow (e.g., 90° elbow), flange with hose barb 1310. Also attached to the tec, port flange 1308 is an adapter, flange with hose barb 1312, by way of a third flange clamp 1304 and a third skirted flange gasket 1306. The non-aux valve option tank port assembly 1300A also includes a second subassembly not attached to the first subassembly that includes a first flange with male thread 1302, a first flange clamp 1304, a first skirted flange gasket 1306, and an elbow (e.g., 90° elbow), flange with hose barb 1310.

The aux valve option tank port assembly 1300B includes a first subassembly that includes a first flange with male thread 1302, a first flange clamp 1304, a first skirted flange gasket 1306, and an elbow (e.g., 90° elbow), flange with hose barb 1310. The aux valve option tank port assembly 1300B also includes a second subassembly not attached to the first subassembly that includes a first flange with male thread 1302, a first flange clamp 1304, a first skirted flange gasket 1306, and an elbow (e.g., 90° elbow), flange with hose barb 1310.

The liquid fertilizer tank only tank port assembly 1300C includes a first subassembly that includes a first flange with male thread 1302, a first flange clamp 1304, a first skirted flange gasket 1306, and an elbow (e.g., 90° elbow), flange with hose barb 1310. The liquid fertilizer tank only tank port assembly 1300C also includes a second subassembly not attached to the first subassembly that includes a plug 1316 to make the second subassembly non-operational.

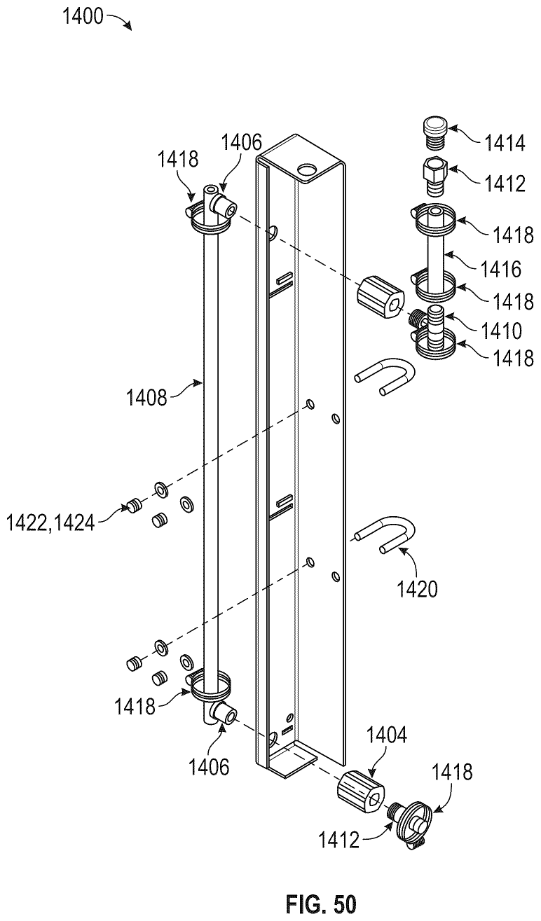

FIG. 50 shows a fertilizer level sight assembly 1400. The fertilizer level sight assembly 1400 includes fertilizer level sight glass, which indicates how much liquid is left in fertilizer tanks. The planter 1010 is preferably on level ground as the reading is being taken to increase accuracy of the reading. The fertilizer level sight assembly 1400 includes a mounting bracket that secures to the rest of the agricultural implement 1000 (FIG. 37) by way of u-bolts 1420, washers, and lock nuts 1424.

The fertilizer level sight assembly 1400 includes a clear tube 1408 with a hollow ball 1426. The clear tube 1408 includes a hose clamp 1418 and an elbow 1406 at each end. Each elbow 1406 is placed through a hole in each end of an adjacent mounting bracket. The elbows 1406 each attach to a poly coupler 1404, a barbed fitting 1412, and a hose clamp 1418. The top poly coupler 1404, top barbed fitting 1412, and top hose clamp 1418 are further attached to a clear vinyl hose 1416 (at one end of the clear vinyl hose 1416). At the other end of the clear vinyl hose 1416 there is a breather vent 1414 with a barbed fitting 1412 and a hose clamp 1418 located therebetween.

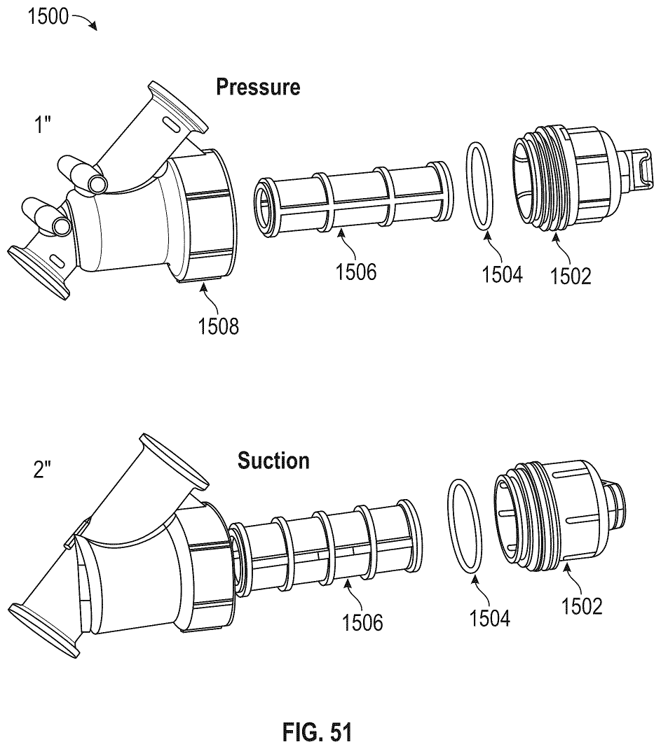

FIG. 51 shows manifold y strainer assembly 1500 in pressure (top) and suction (bottom) configurations. The manifold y strainer assembly 1500 comprises a cap assembly 1502, an O-ring 1504, a mesh screen 1506, and a manifold body 1508. The manifold y-strainer assembly 1500 removes solid particles from the liquid fertilizer like steam, gas, or foreign liquids to protect downstream equipment from damage. The O-ring 1504 helps seal the lower portion of the male-threaded cap assembly 1502 to the female-threaded manifold body 1508. The manifold body 1508 diverts flow from the FIG. 44 through the mesh screen 1506 before passing the fertilizer fluid to downstream components. The mesh screen 1506 operates as the strainer's filtering element to trap particles like rust, scale, debris, and sediment, helping ensure the reliable and efficient operation of downstream equipment. The manifold y strainer assembly 1500 reduces the need for equipment cleaning and maintenance, which helps keep the process flow steady.

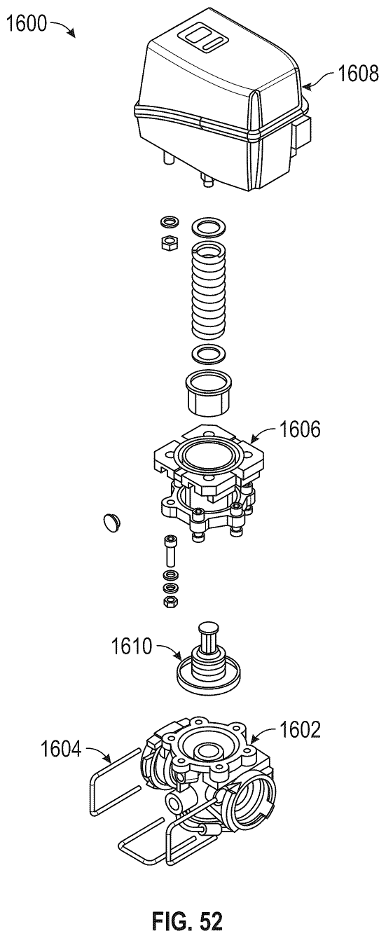

FIG. 52 shows a pressure regulator 1600. The pressure regulator includes a body press valve 1602, forks 1604 (which are similar to u-bolts), a motor support 1606, a motor 1608, and a diaphragm and pressure valve 1610. The body press valve 1602 is installed using a press-fit method, which involves mechanically pressing fittings together to join the pressure regulator 1608 to the pipes of the flow meter assembly 900. The body press valve 1602 is a safe, fast, and more reliable option for quick installation and de-installation of the pressure regulator 1600. The motor 1608 powers the pressure regulator 1600 and is mounted to the body press valve 1602 by way of the motor support 1606. The diaphragm and pressure valve 1610 is a flexible diaphragm that serves as a flow control device, either obstructing, regulating, or isolating fluid fertilizer flow. The diaphragm valve and pressure valve 1610 operates by adjusting the position of the diaphragm to regulate the fluid flow rate. When the diaphragm presses firmly against its seat, the diaphragm and pressure valve 1610 is closed and the flow is halted.

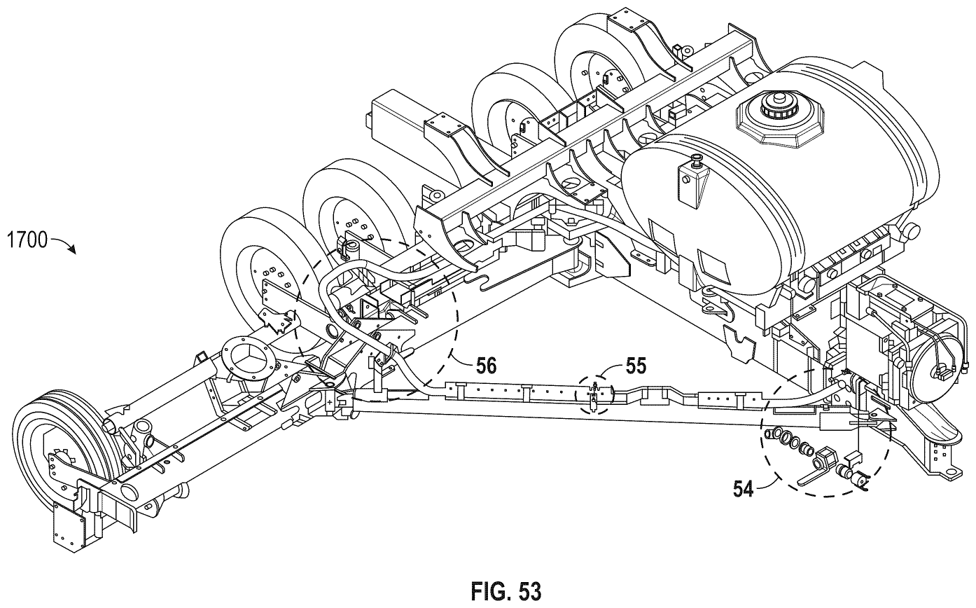

FIGS. 53-56 shows plumbing at the front hitch 1700. As shown in FIG. 53, the front hitch auxiliary plumbing 1700 is used to connect to tractor tanks. The front auxiliary valve located on the front hitch 1700 should be opened when hooked to a tractor tank for the planting season, it can remain open all season while hooked to tractor tanks. Before disconnecting planter from tractor, the front hitch auxiliary plumbing should be closed the fluid supply from tractor tanks disconnected.

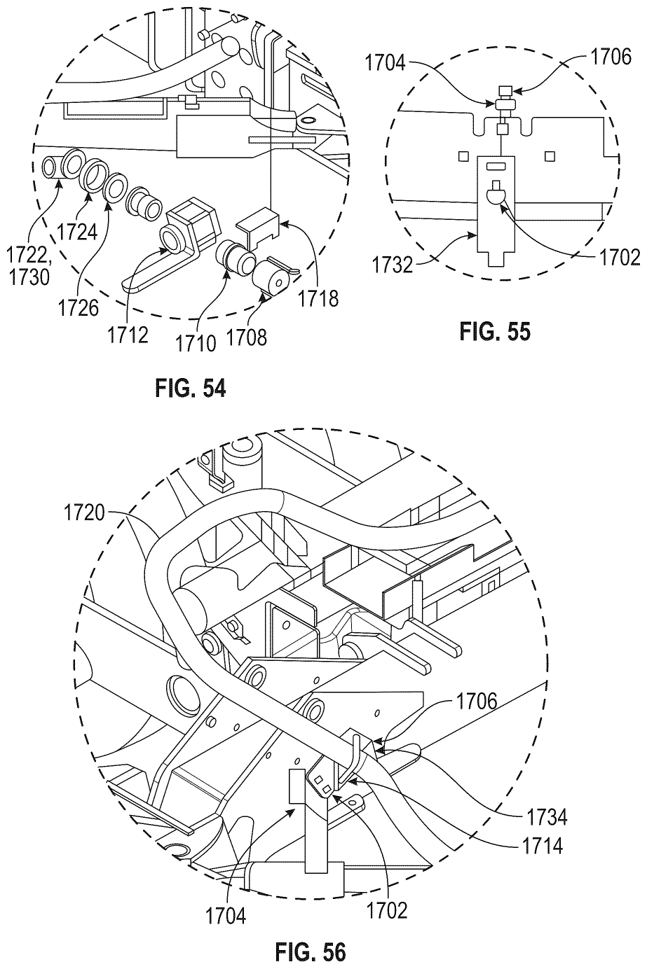

As shown in FIG. 54, the front hitch 1700 includes a shutoff valve 1712. Upstream of the shutoff valve 1712, there is a dust cap 1708 and an adapter 1710 that receives liquid fertilizer from a liquid fertilizer source. The shutoff valve 1712 attaches to the rest of the agricultural implement 1000 by way of a tractor fertilizer valve mount 1718. Downstream of the shutoff valve 1712, the shutoff valve 1712 fluidly connects to a flange with male thread 1728. The flange with male thread 1728 fluidly connects to an elbow 1722 by way of a flange clamp 1724, a skirted flange gasket 1726. A hose clamp 1730 connects the front hitch plumbing 1700 to the rest of the fluidic components of the agricultural implement 1000.

As shown in FIGS. 55-56, a carriage bolt 1702 of a fertilizer hose riser bracket 1714 attaches to a fertilizer hose clamp 1732 by way of washers 1704 and lock nuts 1706. The front hitch plumbing 1700 includes hoses 1720, which are held in place with the fertilizer hose riser bracket 1714.

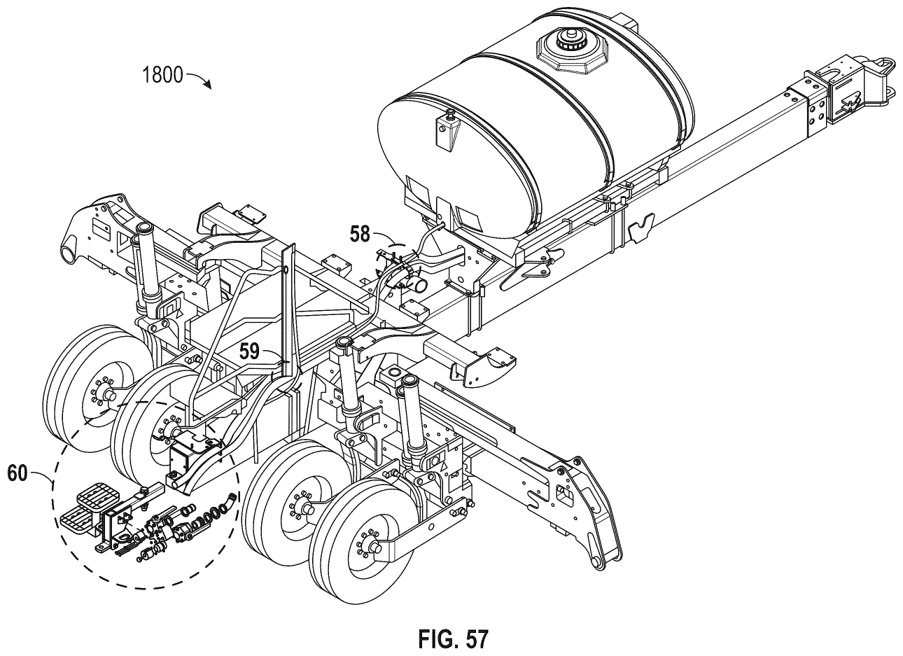

FIGS. 57-60 shows plumbing at a rear trailer hitch 1800. As shown in FIG. 57, the rear trailer hitch 1800 is used to tow a 3 or 4 wheel wagon behind the planter 1010. Hitch height during field operation and transport at 15″. Hitch height will raise to approximately 42″ when planter is lifted. The rear trailer hitch 1800 is designed for use with the diaphragm pump 1100. A maximum hitch weight can be, but is not required to be, 200 lbs (˜90 kg) and a maximum gross towing weight can be, but is not required to be, 6000 lbs (˜2720 kg) or the equivalent of a loaded 500 gal (˜1890 L) tank and running gear or equipment can be damaged. Periodically checking the feed hose for kinks can prevent a restricted delivery rate.

Adjust rear trailer hitch length by loosening the ⅝″ set screws at rear of outer tube, removing the 1″×8½″ bolt at the center of the hitch, and sliding the hitch in or out to one of the four sets of adjustment holes. The hardware is then reinstalled and tightened.

There is also a rear auxiliary valve located on the board bulk fill valve in the rear of the planter so you can pull from a tank on a trailer if you have a trailer hitch. This is an optional feature, as there can be planters 1010 that omit the rear trailer hitch 1800 entirely.

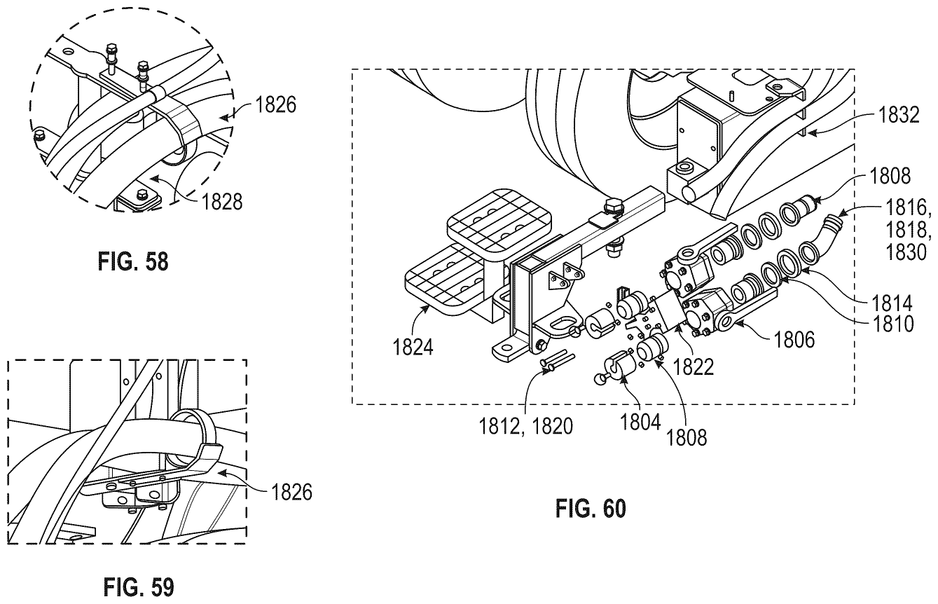

As shown in FIGS. 58-59, a hose 1828 is held in place with a hose hanger 1826.

With reference to each of FIGS. 53-60, the auxiliary plumbing 1700, 1800 (front or rear) pulls fluid from an auxiliary source with the onboard positive displacement pump, then is applied with the fertilizer system 400, 500 and controlled with the user interface (FIG. 16). There should be enough slack in the hoses between the tractor and the planter 1010 so that the planter 1010 can easily make turns and the planter can be lifted and lowered with lifting actuators 1031. The two valves can be switched under the onboard tank and the valve at the point of auxiliary hook up cither at the front of the planter for tractor tank or on the rear hitch of the planter 1010 for the trailer tank.

As shown in FIG. 60, auxiliary fertilizer hose bracket 1832 further secures the hoses 1828. One of the hoses 1828 attaches to an adapter 1832. The other hose 1828 attaches to a flange with hose barb elbow 1818 by way of a hose clamp 1816. The flange with hose barb elbow 1818 fluidly connects to a flange with male thread 1802 by way of a skirted flange gasket 1810 and a flange clamp 1814. The flange with male thread 1802 fluidly connects to a shutoff valve 1806. The shutoff valve 1806 is mounted by way of fertilizer trailer valves mount 1822. A pair of dust caps 1804 and adapters to cam locks 1808, by way of flange nuts 1812 and hex head cap screws 1820. FIG. 60 also shows rear trailer hitch steps 1824.

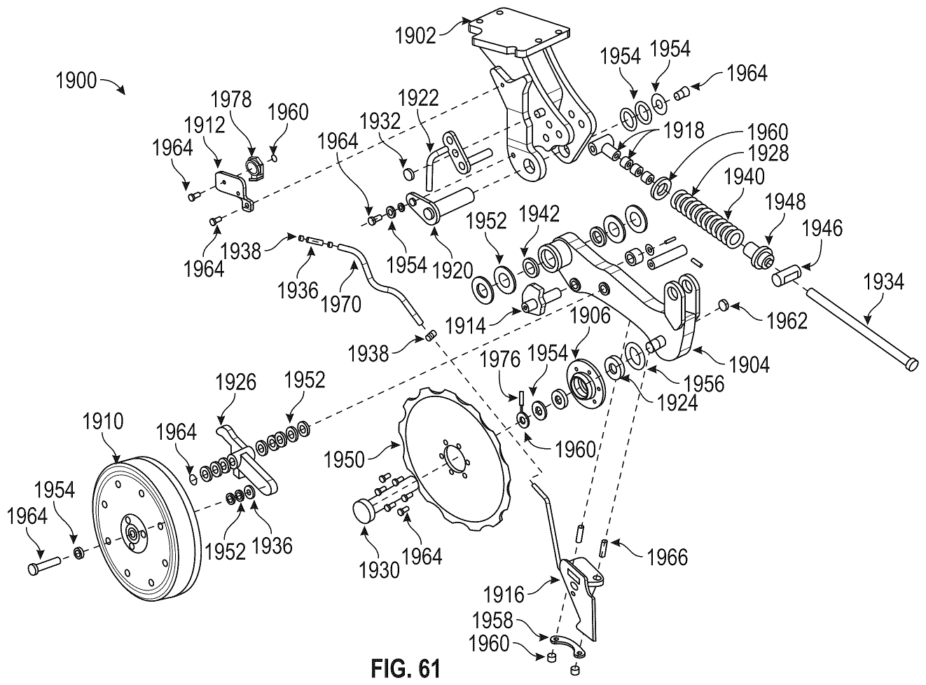

FIGS. 61-63 show a notched single disc fertilizer opener 1900.

The notched single disc opener 1900 can be placed in three positions-stowed (position 1) and two operating positions (positions 2 and 3) to match field conditions. The notched single disc fertilizer opener 1900 will rest in positions 1 and 3, but must be held in position 2 until being secured in place by a handle pin. The position of the notched single disc fertilizer opener 1900 can be changed by grasping the notched single disc fertilizer opener 1900 with one hand directly below the coulter bearing. With the other free hand, the lynch pin 1932 and the handle pin can be removed from the notched single disc fertilizer opener 1900. Then, the notched single disc fertilizer opener 1900 is pulled up on slightly and a spring tee is lifted out of current location. The notched single disc fertilizer opener 1900 is lowered until the tee rests in the desired position. The handle pin is installed into the desired hole position, passing the pin through the spring tec. The lynch pin 1932 is then reinstalled to lock the notched single disc fertilizer opener 1900 in place.

As shown in FIG. 61, the notched single disc opener 1900 comprises an opener mount 1902. A hammer strap 1920 attaches to the opener mount 1902 with a hex head cap screw 1964, a flat washer 1954, and a bushing 1952. The hammer strap 1920 includes a cylindrical member which passes through two holes located at the bottom of the opener mount 1902 and then secures to a hex flat head cap screw 1964 by way of a countersunk washer 1954 and an 18 gauge washer 1954. A lynch pin 1932 and a stow pin 1922 help an car member of the notched single disc opener 1900 to the opener mount 1902. A loop plate 1912 and a fertilizer air lock loop holder 1978 secure to said car member of the notched single disc opener 1900 by way of hex head cap screws 1964 and lock nuts 1960.

One end of the opener arm 1904 secures to the opener mount 1902 near the two holes with a seal 1942 on a bushing 1952 on each side of the cars. A tee 1918 allows the opener arm 1904 to pivot with respect to the opener mount 1902. The tec 1918 attaches to a spring seat 1928 with hex nuts 1960. The spring seat 1928 allows the spring 1940 to sit therein. At the other end of the spring 1940, a spring spindle 1948 attaches to a pin sleeve 1946, which attaches to a special bolt 1934.

A disc blade 1950 attaches to the opener arm 1904 at the other end. A hub 1906 attaches to the opener arm 1904 at one side by way of a tapered roller 1924 and an oil seal 1956, with a grease fitting 1962 holding it in place on the opposite side of the opener arm 1904. The hub also attaches to the disc blade 1950 by way of a bushing 1952, a hardened spindle washer 1954, a spring pin 1976, and a slotted nut 1960. The disc blade 1950 is secured in place with a dust cap 1930 at a center of the disc blade 1950 and several hex head cap screws 1964 radially arranged about an outermost perimeter of the dust cap 1930.

At a central location, the opener arm 1904 includes a gauge wheel adjust 1914, which is a star knob that can adjust the position of the gage wheel assembly 1910. The gage wheel assembly 1910 attaches to the opener arm 1904 by way of many bushings 1952, a gauge wheel arm 1926, many more bushings 1952 and washers 1954, an adapter 1936 and a hex flange head cap screw 1964, which make direct attachment to the gage wheel assembly 1910. The gauge wheel of the gage wheel assembly 1910 can rotate as the gauge wheel arm 1926 rotates. A lock washer 1954 and a hex head cap screw 1964 pass through the center of the gauge wheel of the gage wheel assembly 1910 and attach to the gauge wheel arm 1926.

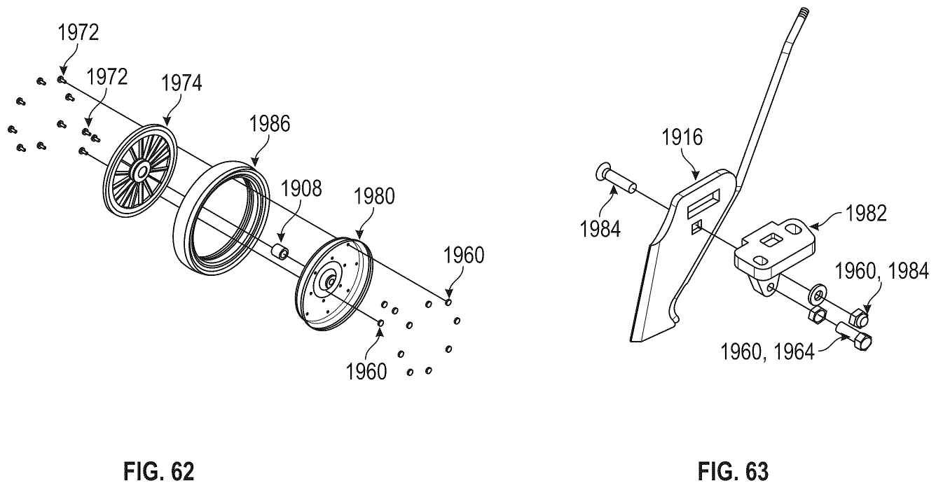

As shown in FIG. 62, the gauge wheel of the gauge wheel assembly 1910 includes a gauge wheel cover 1974, an offset tire 1984 located concentrically outward from the gauge wheel cover 1974, and a half wheel 1980 located concentrically inward from the offset tire 1986, all held in place with flanged whiz lock screws (no serration 1972) and serrated flange nuts 1960. A bearing 1908 is located in the center of the gauge wheel.

The gauge wheel assembly 1910 includes an adjustable wheel attached to the planter 1010 or plow that controls the depth at which it penetrates the soil. The gauge wheel has several functions, including: maintaining furrow sidewalls and protecting the sidewalls from being torn apart by the opener blade; maintaining furrow shape as the seed blade passes through; creating a clean furrow for precise seed placement; helping keep the planter 1010 or drill running at a consistent depth throughout the planting process; absorbing residue in no-till conditions; preventing water-clogging, holes, or depressions that can collect excessive water. The gauge wheel is located near where the seed is dropped during planting.

Secured to the bottom of the opener arm 1904, there is a fertilizer knife 1916 that attaches thereto by way of a fertilizer knife double plate 1958 and lock nuts 1960. The fertilizer knife 1916 attaches to a clear plastic tube 1970 near the top of the fertilizer knife 1916, by way of a hose clamp 1938. As shown in FIG. 63, the fertilizer knife 1916 is laterally held in position with a knife mount 1982, which secures to one side of the fertilizer knife 1916 with a lock nut with a nylon insert 1960 and a flat head plow bolt 1984 at a first location; and, at a second location, a hex jam nut 1960 and a hex head cap screw 1964. At the other side of the fertilizer knife 1916, a flat head plow bolt 1984 holds the knife mount 1982 in place.

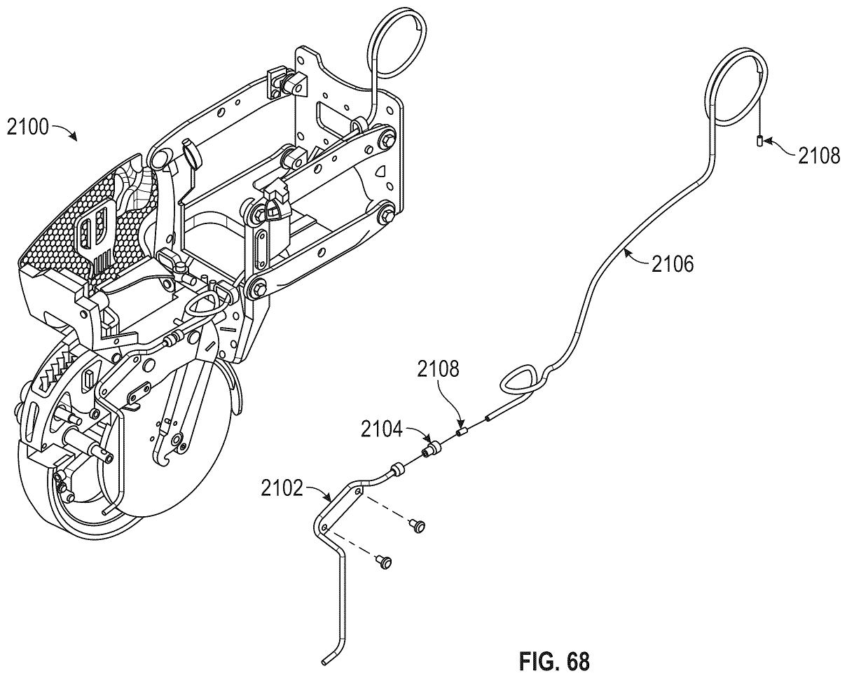

At an opposite end of the clear plastic tube 1970, an adapter 1936 and a hose clamp 1936 allow fluidic connection from an upstream location in the liquid fertilizer system 500, to pass through the notched single disc opener 1900, and be deposited at the furrow (see also the liquid fertilizer tube in furrow 2100 configuration that is shown in FIG. 68).

The fertilizer knife 1916 can be adjusted such that the leading edge is tight to the disc blade 1950 to keep soil and residue from wedging between them. Knife pitch can also be adjusted to provide a more beneficial performance. The fertilizer knife 1916 to disc blade 1950 gap can be preset to ⅜″, measured at the top or rear of the fertilizer knife 1916.

Fertilizer depth is adjustable from approximately 2″ to 4″ (5 to 10 cm) when the planter frame is level and at proper 24″ (61 cm) operating height. Soil conditions will affect fertilizer placement depth. Down force settings that correspond to said soil conditions and the size of the notched single disc fertilizer opener 1900 are shown in Table 1 below.

TABLE 1
Down Force Settings
Down Force Settings

| | 9″ (23 cm) | 8.5″ (21 cm) | 8″ (20 cm) |
|---|---|---|---|
| Position 1 (stowed) | N/A | N/A | N/A |
| Position 2 (softer | 110-160 lbs | 150-210 lbs | 200-250 lbs |
| soil conditions) | (~50-75 kg) | (~70-95 kg) | (~90-115 kg) |
| Position 3 (harder | 180-240 lbs | 250-285 lbs | 290-350 lbs |
| soil conditions) | (~80-110 kg) | (~115-130 kg) | (~130-160 kg) |

The spring 1940 of the notched single disc fertilizer opener 1900 can be preset to correspond to one or more coulter heights selected from the group consisting of: 9″ (23 cm), 8.5″ (21 cm), or 8″ (20 cm). The spring 1940 can be adjusted to the others as desired depending on soil conditions. Position 2, for example, is beneficial for conventional tillage and softer conditions. Position 3 is used for no-till and harder soil conditions. In positions 1 and 2, coulter height can be further adjusted manually if needed by loosening the main bolt jam nut 1960 and special bolt 1934 up to 10 turns for an additional inch. Approximately ¼″ of bolt length adjustment provides nearly 1″ (2.5 cm) of coulter height change. The recommended maximum disc blade depth is 4″ (10 cm). If clearance between the fertilizer knife 1916 to disc blade 1950 is too large, soil or residue can wedge between the fertilizer knife 1916 to disc blade 1950, and the disc blade 1950 will not turn.

The spring 1940 is biased so strongly that it is not recommended to disassemble the spring 1940 from the notched single disc fertilizer opener 1900, as it can cause injury. Similarly the disc blade 1950 is so sharp that caution should be taken while handling, e.g., wearing gloves where contact is needed to turn the disc blade 1950. The fertilizer knife 1916 should be kept free from contact with large objects, as damage to the fertilizer knife 1916 can occur.

The notched single disc fertilizer opener 1900 operates with the gauge wheel 1910 as the primary depth stop when in position 3. In softer conditions, position 2 can be used to control depth using the gauge wheel as well as planter frame to limit opener travel. In all positions, the opener will spring up when encountering a foreign object or hard ground.

The gauge wheel depth adjust 1914 is rotated to adjust depth of fertilizer placement into the soil. The handle is pulled out and the gauge wheel depth adjust 1914 is rotated in sixty degree increments to achieve desired depths. Many depths can be made available. In the configuration shown, there are six depths available, with 2″ being the shallowest option and 4″ being the deepest option.

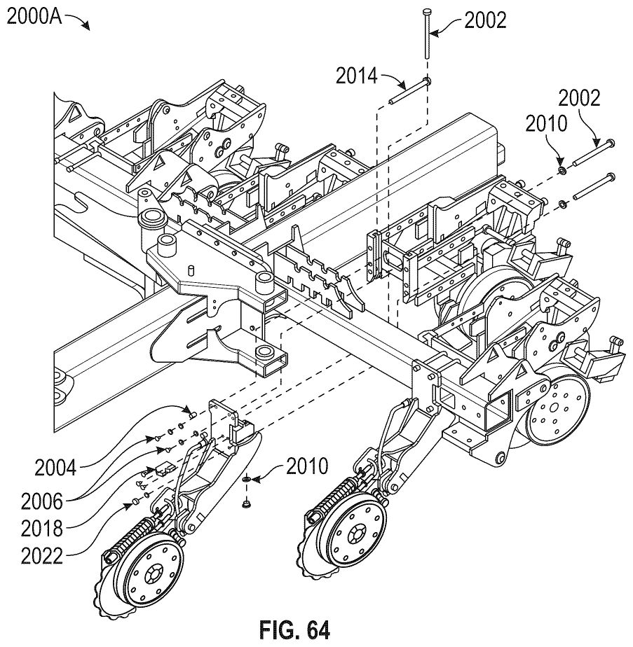

FIGS. 64-67 show additional examples of mounting hardware 2000A-2000D configurations, e.g. extended mounts 2000A, 2000C, a right-angle mount 2000B, and a flat mount 2000D, for the notched single disc fertilizer opener 1900. The notched single disc fertilizer opener mounts 1902, 2000A-2000D can be loosened or tightened ½″ to adjust the leading edge of the fertilizer knife 1916 to be tight against the disc blade 1950 from top to bottom. The disc blade 1950 can be turned and check for slight drag without freewheeling. The knife tension can be readjusted to accommodate blade high spots as needed. If the knife pitch is such that the gap is less than ⅜″ (measured at the top rear of the fertilizer knife 1916), residue and soil may wedge between the fertilizer knife 1916 and disc blade 1950, causing resistance to disc blade rotation. If the fertilizer knife 1916 is pitched such that the gap exceeds ⅜″ (measured at the top rear of the fertilizer knife 1916), accelerated wear on the fertilizer knife 1916 and fertilizer drop tube 2102 will result.

As shown in FIG. 64, an extended mount 2000A mounts the notched single disc fertilizer opener 1900 to an outermost portion of the toolbar using hex head cap screws 2002, set screws 2004, lock nuts 2006, flat washers 2010, an interlock bracket 2018, and a hex serrated cap screw 2022.

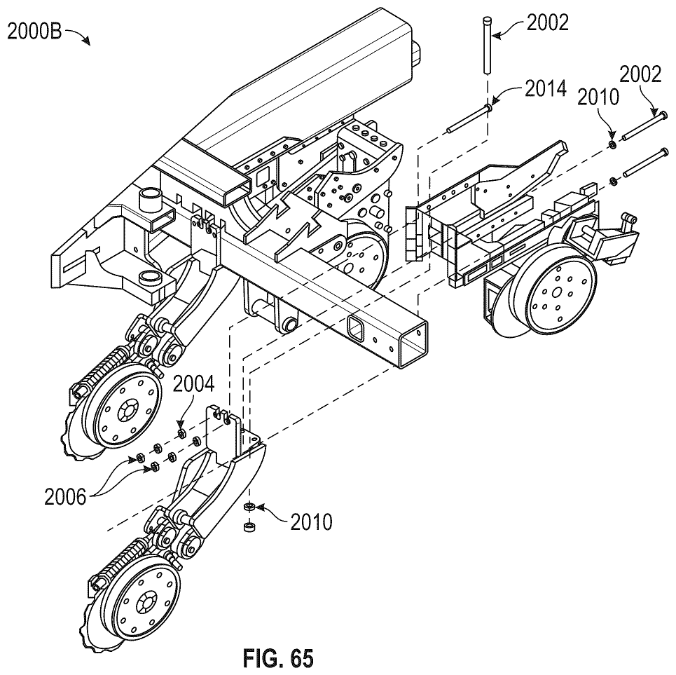

As shown in FIG. 65, a right-angle mount 2000B mounts the notched single disc fertilizer opener 1900 to an inner portion of the toolbar using hex head cap screws 2002, set screws 2004, lock nuts 2006, flat washers 2010, and eye bolts 2014.

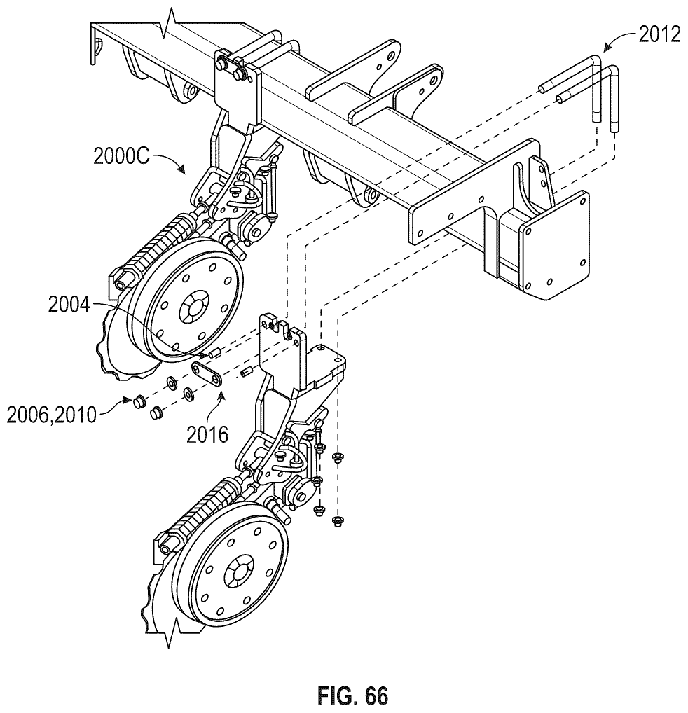

As shown in FIG. 66, an extended mount 2000C mounts the notched single disc fertilizer opener 1900 to an inner portion of the toolbar using set screws 2004, lock nuts 2006, flat washers 2010, L-bolts 2012, and a retainer 2016.

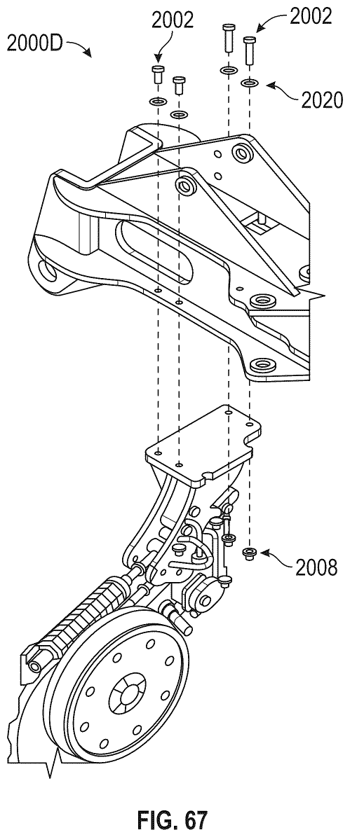

As shown in FIG. 67, an extended mount 2000A mounts the notched single disc fertilizer opener 1900 to an underside of the toolbar using hex head cap screws 2002, flange nuts 2008, and lock washers 2020.

FIG. 68 shows a liquid fertilizer tube in furrow 2100 for the notched single disc opener 1900. The liquid fertilizer tube in furrow 2100 comprises a fertilizer drop tube 2102, which is attached to further tubing 2106 by way of a connector 2104 and a support tube 2108.

Once the fertilizer knife 1916 has been adjusted into position, the top end of the fertilizer drop tube 2102 can be adjusted accordingly to ensure adequate clearance to the opener mount 1902 and the gauge wheel 1910 through the entire range of motion for the notched single disc fertilizer opener 1900. The in furrow option of FIG. 68 is available for in-line installation and ensure equal distribution of product at low rates and siphon protection for field turns.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 90 | fertilizer flow meter assembly |
| 91 | paddle wheel |
| 92 | nozzle orifice |
| 93 | fertilizer shutoff |
| 94 | fertilizer manifold cap |
| 95 | strainer nozzle |
| 100 | adjustable liquid flow system |
| 102 | jet nozzle |
| 104 | fertilizer shutoff |
| 106 | fertilizer manifold cap |
| 108 | strainer |
| 110 | fertilizer flow meter assembly |
| 112 | paddle wheel cavity |
| 114 | flange |
| 116 | nozzle assembly |
| 118 | nut |
| 120 | flow meter manifold |
| 122 | gasket |
| 124 | orifice |
| 124A | blank side |
| 124B | stamped side |
| 126 | direction of delivery |
| 128 | manifold flow meter cover |
| 130 | paddle assembly |
| 132 | wire retention clip |
| 134 | lower housing |
| 136 | first O-ring |
| 138 | dust cap assembly |
| 140 | proximity sensor |
| 142 | pan head tapping screw |
| 144 | second O-ring |
| 146 | plastic shim |
| 148 | orifice in-line housing assembly |
| 150 | connector |
| 152 | orifice cushion adaptor |
| 154 | cap |
| 156 | support tube |
| 200 | adjustable insert |
| 202 | planar region of flow control surface |
| 203 | annular flange |
| 204 | non-planar region of flow control surface |
| 205 | inflection point |
| 206 | tapered region of flow control surface |
| 207 | central bore |
| 208 | vents |
| 210 | actuatable component |
| 212 | magnetic component |
| 214 | direction of actuation |
| 214A | direction of spring force |
| 214B | direction of magnetic force |
| 300 | liquid flow at flow meter |
| 301 | first (e.g. central) flow path |
| 302 | second (e.g. substantially annular or conical) flow path |
| 304A | divested flow profile |
| 304B | focused flow profile |
| 304C | uniform flow |
| 400 | liquid fertilizer application system |
| 402 | row units |
| 404 | conduit |
| 406 | positive displacement pump (e.g., diaphragm pump) |
| 408 | drive source (e.g., hydraulic motor) |
| 410 | electric ball valve |
| 412 | first filtering device (e.g., suction strainer) |
| 414 | flow switch |
| 416 | first pressure gauge |
| 418 | second filtering device (e.g., pressure strainer) |
| 420 | pressure regulator |
| 422 | flowmeter |
| 422A | high flow meter |
| 422B | low flow meter |
| 424 | second pressure gauge |
| 426 | third pressure gauge |
| 428 | row unit shutoffs |
| 430 | fourth pressure gauge |
| 432 | tractor or trailer tank |
| 434 | on board tank |
| 436 | aux connection valve |
| 438 | rear fill valve |
| 440 | aux valves |
| 442 | suction valve |
| 444 | flow meter transition valve |
| 446 | rail pressure sensor |
| 500 | liquid fertilizer system for an agricultural implement (e.g., |
| | planter) |
| 502 | lefthand fertilizer mount bracket |
| 504 | righthand fertilizer mount bracket |
| 506 | first hoses |
| 508 | second hoses |
| 510 | third hoses |
| 512 | bulk fill hose |
| 514 | auxiliary hose |
| 516 | clear tube |
| 518 | fourth hoses |
| 520 | fifth hoses |
| 522 | sixth hoses |
| 524 | lock nut |
| 526 | hex head cap screw |
| 528 | manifold fan control |
| 530 | connector with O-ring |
| 532 | hex socket head cap screw |
| 534 | pump mount plate |
| 536 | u-bolt |
| 538 | hydraulic motor |
| 540 | speed sensor gear tooth |
| 542 | washer |
| 544 | carriage bolt |
| 546 | hex standoff |
| 548 | spacer |
| 550 | IPN mount |
| 552 | IPN cover |
| 554 | IPN module assembly |
| 556 | fertilizer module harness |
| 558 | Ethernet cable |
| 560 | manifold mount |
| 562 | hex socket set screw |
| 564 | support tube |
| 566 | pressure gauge |
| 568 | elbow (e.g., 90° elbow) |
| 570 | coupling |
| 572 | pressure gauge mount |
| 600 | fertilizer manifold |
| 602 | washer |
| 604 | lock nut |
| 606 | u-bolt |
| 608 | hex head cap screw |
| 610 | manifold mount |
| 612 | hose |
| 614 | fertilizer tube mount |
| 616 | flange clamp |
| 618 | skirted flange gasket |
| 620 | fertilizer manifold clamp with straight nozzle |
| 622 | flanged fitting (e.g., 90° flanged fitting) |
| 624 | flanged plug |
| 626 | flanged barb |
| 628 | flanged barb fitting (e.g., 45° flanged fitting) |
| 630 | heavy duty hose clamp |
| 632 | fertilizer manifold section(s) |
| 634 | adapter |
| 700 | fertilizer tank system |
| 702 | washer |
| 704 | hex head cap screw |
| 706 | hose clamp |
| 708 | lock nut |
| 710 | hex pipe plug |
| 712 | hollow ball |
| 714 | flange nut |
| 716 | elbow (e.g., 90° elbow) |
| 718 | band |
| 720 | barbed fitting |
| 722 | tank pad |
| 724 | clear tube |
| 726 | u-bolt |
| 728 | adapter |
| 730 | liquid level sensor |
| 732 | fertilizer tank (e.g., 400 gallon tank, 500 gallon tank, 750 |
| | gallon tank, etc.) |
| 734 | front support |
| 736 | rear support |
| 738 | tank mount |
| 740 | edge trim protection |
| 742 | flange clamp |
| 744 | flange with barb elbow |
| 746 | flange gasket |
| 748 | flange with male thread |
| 750 | dust cap |
| 752 | fertilizer fill valve mount bracket |
| 754 | three-way valve |
| 756 | site gauge bracket |
| 758 | tee |
| 760 | nipple |
| 762 | support |
| 764 | insulated clamp |
| 766 | pressure gauge mount |
| 768 | anchor |
| 770 | fertilizer tube support bracket |
| 772 | fertilizer fill valve mount plate |
| 800 | fertilizer electric valve assembly |
| 802 | electric ball valve assembly |
| 804 | skirted flange gasket |
| 806 | liquid level sensor |
| 808 | plug |
| 810 | tee |
| 812 | manifold Y strainer |
| 814 | plumbing bracket |
| 816 | elbow |
| 818 | flange clamp |
| 820 | u-bolt |
| 822 | lock nut |
| 824 | washer |
| 826 | hex head cap screw |
| 828 | hose clamp |
| 830 | hydraulic pressure transmitter sensor |
| 832 | coupling |
| 900 | flow meter assembly |
| 902 | flow meter flanged adapter |
| 904 | adapter flange with hose barb |
| 906 | mini flow meter sensor |
| 908 | flow meter |
| 910 | manifold flanged check valve |
| 912 | flanged fitting |
| 914 | electric ball valve with harness |
| 916 | flanged plug |
| 918 | mini flow meter |
| 920 | plumbing bracket |
| 922 | flange with barb |
| 924 | skirted flange gasket |
| 926 | flange clamp |
| 928 | heavy duty hose clamp |
| 930 | hex head cap screw |
| 932 | washer |
| 934 | lock nut |
| 936 | u-bolt |
| 938 | push to connect adapter |
| 940 | support tube |
| 942 | connector |
| 944 | pressure sensor |
| 946 | elbow with gauge port flange sweep |
| 948 | hex nut |
| 950 | flanged tee |
| 952 | male hose fitting with clamp coupling |
| 954 | flanged poly cross |
| 956 | O-ring |
| 1000 | agricultural implement |
| 1010 | planter |
| 1012 | tongue |
| 1014 | first end |
| 1016 | hitch |
| 1018 | central toolbar |
| 1020 | draft links |
| 1022 | folding actuators |
| 1024 | central hoppers |
| 1026 | fans |
| 1028 | transport wheels |
| 1030 | first wing |
| 1031 | lifting actuators |
| 1032 | first wing toolbar |
| 1033 | first marker |
| 1034 | second wing |
| 1035 | second wing toolbar |
| 1036 | second marker |
| 1037 | marker actuators |
| 1038 | wheels |
| 1040 | row units |
| 1100 | diaphragm pump |
| 1102 | diaphragm pump assembly |
| 1104 | flange hydraulic motor |
| 1106 | flange hydraulic motor mount |
| 1108 | coupler with hall effect wheel |
| 1110 | key |
| 1112 | hex socket head cap screw |
| 1114 | hex head cap screw |
| 1116 | hex locknut |
| 1118 | first manifold sections |
| 1120 | section manifold sections |
| 1122 | third manifold section |
| 1124 | foot mount |
| 1126 | fork clip |
| 1128 | oil drain plug |
| 1130 | ring nut |
| 1132 | hose barb |
| 1134 | fourth manifold section |
| 1136 | hub pin |
| 1138 | fifth manifold section |
| 1140 | tank sight glass |
| 1142 | manifold mount bolt |
| 1144 | plate |
| 1146 | sight glass cap |
| 1148 | drain plug |
| 1150 | square plug |
| 1200 | fertilizer junction assembly |
| 1202 | washer |
| 1204 | lock nut |
| 1206 | fertilizer junction bracket |
| 1208 | flanged poly cross |
| 1210 | adapter flange with hose barb |
| 1212 | u-bolt |
| 1214 | flange clamp |
| 1216 | flange with barb |
| 1218 | skirted flange gasket |
| 1220 | heavy duty hose clamp |
| 1300A | non-aux valve option tank port assembly |
| 1300B | aux valve option tank port assembly |
| 1300C | liquid fertilizer tank only tank port assembly |
| 1302 | flange with male thread |
| 1304 | flange clamp |
| 1306 | skirted flange gasket |
| 1308 | tee, port flange |
| 1310 | elbow (e.g., 90° elbow), flange with hose barb |
| 1312 | adapter, flange with hose barb |
| 1314 | hose clamp |
| 1316 | plug |
| 1318 | heavy duty hose clamp |
| 1400 | fertilizer level sight assembly |
| 1402 | liquid fertilizer sight gauge |
| 1404 | poly coupler |
| 1406 | elbow |
| 1408 | clear tube |
| 1410 | tee |
| 1412 | barbed fitting |
| 1414 | breather vent |
| 1416 | clear vinyl hose |
| 1418 | hose clamp |
| 1420 | u-bolt |
| 1422 | flat washer |
| 1424 | lock nut |
| 1426 | hollow ball |
| 1500 | manifold Y strainer assembly |
| 1502 | cap assembly |
| 1504 | O-ring |
| 1506 | mesh screen |
| 1508 | manifold body |
| 1600 | pressure regulator |
| 1602 | body press valve |
| 1604 | fork |
| 1606 | motor support |
| 1608 | motor |
| 1610 | diaphragm and pressure valve |
| 1700 | front hitch plumbing |
| 1702 | carriage bolt |
| 1704 | washer |
| 1706 | lock nut |
| 1708 | dust cap |
| 1710 | adapter |
| 1712 | shutoff valve |
| 1714 | fertilizer hose riser bracket |
| 1716 | u-bolt |
| 1718 | tractor fertilizer valve mount |
| 1720 | hose |
| 1722 | elbow |
| 1724 | flange clamp |
| 1726 | skirted flange gasket |
| 1728 | flange with male thread |
| 1730 | hose clamp |
| 1732 | fertilizer hose clamp |
| 1734 | hex nut |
| 1800 | rear trailer hitch plumbing |
| 1802 | flange with male thread |
| 1804 | dust cap |
| 1806 | shutoff valve |
| 1808 | adapter to cam lock |
| 1810 | skirted flange gasket |
| 1812 | flange nut |
| 1814 | flange clamp |
| 1816 | hose clamp |
| 1818 | flange with hose barb elbow |
| 1820 | hex head cap screw |
| 1822 | fertilizer trailer valves mount |
| 1824 | rear trailer hitch steps |
| 1826 | hose hanger |
| 1828 | hose |
| 1830 | auxiliary fertilizer hose bracket |
| 1832 | adapter |
| 1900 | notched single disc fertilizer opener |
| 1902 | opener mount |
| 1904 | opener arm |
| 1906 | hub |
| 1908 | bearing |
| 1910 | gauge wheel assembly |
| 1912 | loop plate |
| 1914 | gauge wheel adjust |
| 1916 | fertilizer knife |
| 1918 | tee |
| 1920 | hammer strap |
| 1922 | stow pin |
| 1924 | tapered roller |
| 1926 | gauge wheel arm |
| 1928 | spring seat |
| 1930 | dust cap |
| 1932 | lynch pin |
| 1934 | special bolt |
| 1936 | adapter |
| 1938 | hose clamp |
| 1940 | spring |
| 1942 | seal |
| 1944 | shaft pivot |
| 1946 | pin sleeve |
| 1948 | spring spindle |
| 1950 | disc blade |
| 1952 | bushing |
| 1954 | washer (e.g., special, countersunk, lock, flat, etc.) |
| 1956 | oil seal |
| 1958 | fertilizer knife double plate |
| 1960 | nut (e.g., hex nut, lock nut, slotted nut, hex jam nut, etc.) |
| 1962 | fitting (e.g., grease fitting) |
| 1964 | hex head cap screw |
| 1966 | stud |
| 1968 | spring slot pin |
| 1970 | clear plastic tube |
| 1972 | flanged whiz lock screw, no serration |
| 1974 | gauge wheel cover |
| 1976 | spring pin |
| 1978 | fertilizer air lock loop holder |
| 1980 | half wheel |
| 1982 | knife mount |
| 1984 | plow bolt |
| 1986 | offset tire |
| 2000A | extended mount for notched single disc fertilizer opener |
| 2000B | right angle mount for notched single disc fertilizer opener |
| 2000C | extended mount for notched single disc fertilizer opener |
| 2000D | flat mount for notched single disc fertilizer opener |
| 2002 | hex head cap screw |
| 2004 | set screw |
| 2006 | locknut |
| 2008 | flange nut |
| 2010 | flat washer |
| 2012 | L-bolt |
| 2014 | eye bolt |
| 2016 | retainer |
| 2018 | interlock bracket |
| 2020 | lock washer |
| 2022 | hex serrated cap screw |
| 2024 | hose diverter |
| 2100 | liquid fertilizer tube in furrow |
| 2102 | fertilizer drop tube |
| 2104 | connector |
| 2106 | tubing (e.g., black tubing) |
| 2108 | support tube |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An adjustable flow insert for a liquid flow system of an agricultural implement, the adjustable flow inset comprising:
an actuatable component having a control surface designed to compress or expand a flow when moved in relation to an adjacent jet nozzle.

2. The adjustable flow insert of claim 1, wherein the adjustable flow insert has a central bore through which a first flow is always permitted.

3. The adjustable flow insert of claim 1, wherein adjustable flow insert is not capable of completely plugging the flow.

4. The adjustable flow insert of claim 1, wherein the control surface comprises an annular flange.

5. The adjustable flow insert of claim 1, wherein the control surface comprises a non-planar region and an inflection point from which the control surface transitions from concave to convex.

6. The adjustable flow insert of claim 1, wherein the control surface comprises a tapered region.

7. The adjustable flow insert of claim 1, wherein the actuatable component actuates the control surface in a linear direction.

8. The adjustable flow insert of claim 1, wherein the actuatable component actuates the adjacent jet nozzle so as to move toward and away from the control surface.

9. The adjustable flow insert of claim 1, wherein the actuatable component comprises a magnetic actuator that includes a magnetic component and a spring.

10. The adjustable flow insert of claim 1, further comprising vents located toward a periphery of the annular flange allowing some flow to always pass therethrough.

11. The adjustable flow insert of claim 1, wherein the adjustable flow insert comprises radial symmetry.

12. An adjustable liquid flow system for an agricultural implement comprising:
a fertilizer flow meter assembly;
a jet nozzle;
an adjustable flow insert that is linearly actuatable with respect to the jet nozzle, said adjustable flow insert including a flow control surface that utilizes a geometry to control a flow through the flow meter assembly.

13. The adjustable liquid flow system of claim 12, wherein the adjustable flow insert is located upstream of the jet nozzle.

14. The adjustable liquid flow system of claim 12, further comprising conduits carrying liquid fertilizer.

15. The adjustable liquid flow system of claim 12, wherein the fertilizer flow meter assembly further comprises a paddle wheel and is included as part of a manifold row flow assembly, said manifold row flow assembly having a flow meter manifold and a manifold flow meter cover, wherein the manifold row flow assembly further includes a fertilizer shutoff and a fertilizer manifold cap.

16. The adjustable liquid flow system of claim 15, wherein the manifold row flow assembly further comprises a strainer nozzle and an orifice in-line housing assembly that includes an orifice an orifice cushion adaptor, a connector, and a support tube.

17. The adjustable liquid flow system of claim 15, further comprising a positive displacement pump.

18. A method of regulating flow through a manifold row flow assembly, the method comprising:
adjusting an actuatable component of an adjustable flow insert having a control surface designed to compress or expand a flow when moved in relation to an adjacent jet nozzle.

19. The method of claim 18, further comprising increasing a volume of the flow through the manifold row flow assembly or increasing a velocity of the flow through the manifold row flow assembly.

20. The method of claim 18, further comprising allowing an auxiliary flow path, located radially outward from the primary flow path, wherein a cross-sectional area of the auxiliary flow path near the adjacent jet nozzle decreases from a maximum area at a first, open position to zero area at a second, completely closed position, and further wherein the cross-sectional area depends on a distance between the actuatable component of the adjustable flow insert and the adjacent jet nozzle.
